(19) United States
(12) Patent Application Publication
(10) Pub. No.: US 2024/0054355 A1
(43) Pub. Date: Feb. 15, 2024

(54) DIGITAL TWIN FOR ENTITY MANAGEMENT

(71) Applicant: SEKAI DIGITAL TWINS LTD, Ibragg, Swieqi (MT)

(72) Inventors: Kenneth Alan OLLING, Nesodden, Viken (NO); Nataliia CHEILYTKO, Kyiv (UA)

(73) Assignee: SEKAI DIGITAL TWINS LTD, Ibragg, Swieqi (MT)

(21) Appl. No.: 18/260,104

(22) PCT Filed: Dec. 24, 2021
(86) PCT No.: PCT/EP2021/087652

§ 371 Date: Jun. 30, 2023

(30) Foreign Application Priority Data
Dec. 31, 2020 (GB) 2020927.6

(51) Int. Cl. G06N 5/02

(52) U.S. Cl. CPC G06N 5/02

(57) ABSTRACT

A computer-implemented method for synthesizing an operational ontology for a digital twin of a real or virtual entity which includes at least one data source. The method includes obtaining, using an extract transform load, ETL, system, data from the entity, as part of the ETL process, contextualising the obtained data using a plurality of specific ontologies. Each specific ontology includes one or more ontology fragments forming a set of characteristics for a data classification of the data from the entity. For each specific ontology, a representation of that specific ontology is used to contextualise a data classification of the data in a data store. An operational ontology for the entity is synthesized using the plurality of specific ontologies.

### TECHNICAL FIELD

The disclosed technology relates to a method of and system for providing a digital twin to manage an entity which may comprise a number of real and/or virtual components or parts. Examples of such an entity include a so-called “thing” in an Internet of Things, IoT, or Industrial IoT, IIoT, context and also include more complex systems and combination of such complex systems. By way of example, a digital twin may be provided using the disclosed technology for an asset-intensive object such as a building, factory, or smart city, as well as for complex processes and transactions and the like. An entity such as a power station for example may comprise tens or hundreds of thousands of component parts and the digital twin for a power station may comprise millions or billions of smaller digital twins which represent the physical assets of the power station as well as their relationships and the processes they perform.

The disclosed system and method comprise and use respectively a system for and computer implemented method of generating at least one dynamic operational ontology for a real or virtual entity or group of entities which provides a schema in a knowledge graph which can be used to define a digital twin for that real or virtual entity or group of entities and to other related aspects.

### BACKGROUND

Ontology engineering or knowledge representation applies a logics-based ontology to the task of building computable models of a domain for some purpose. For example, ontology engineering can be used to build a digital twin which represents a “thing” such as a real entity (although in some cases the entity may be a virtual entity) in an IoT or IIoT context.

One way of trying to build the capability to allow for evolution in a digital twin environment is to build a “big” enough monolithic ontology schema, however this does not allow for changes to the types of application and to anticipate what types of things or entities may need to use the ontology. Moreover, such big ontologies can be cumbersome to implement, take longer to process, and can thus negatively impact the performance of the ontology and other processes using the digital twins which limits the applicability of this approach to a wide field of applications.

Whilst many ontologies are static, it is known to build ontologies dynamically for structured or unstructured data input. However, such ontologies are built as a conceptual representation of identified data structures.

### SUMMARY STATEMENTS

The present disclosure seeks to mitigate, alleviate or eliminate one or more of the above-identified deficiencies and disadvantages in the prior art to address various problems relating to providing a digital twin for a real entity. For example, some embodiments of the disclosed technology relate to a computer-implemented method for synthesizing an operational ontology for a digital twin of a real or virtual entity which comprises at least one data source. The method comprises obtaining, using an extract transform load, ETL, system, data from the entity, as part of the ETL process, contextualising the obtained data using a plurality of specific ontologies. Each specific ontology comprises one or more ontology fragments forming a set of characteristics for a data classification of the data from the entity. For each specific ontology, a representation of that specific ontology is used to contextualise a data classification of the data in a data store. An operational ontology for the entity is synthesized using the plurality of specific ontologies.

The aspects of the disclosed technology and some preferred embodiments are set out in the accompanying claims.

A first aspect of the disclosed technology comprises a computer-implemented method as set out in claim 1, for example, in some embodiments the first aspect comprises a method for synthesizing a dynamic operational ontology for a digital twin of a real or virtual entity comprising at least one data source, the method comprising: obtaining, using an extract transform load, ETL, system, data from the entity; as part of the ETL process, contextualising the obtained data using at least one specific ontology, wherein each specific ontology comprises one or more ontology fragments, each ontology fragment providing a set of characteristics for a data classification; using a representation of each specific ontology to contextualise the data with the data classification in a data store; synthesizing a dynamic operational ontology for the entity using each specific ontology; and instantiating the dynamic operational ontology as an object in a knowledge graph, wherein the instantiation of the dynamic operational ontology includes geo-spatial and temporal identifiers from each specific ontology from which it was synthesized.

In some embodiments, a specific ontology comprises one or more logic pattern ontology fragments.

Some embodiments of the disclosed methods and related aspects use an ETL, extract, transform, load, module to process unstructured, semi-structured, or unstructured data. Incoming data is processed by the ETL, for example, a machine learning module may be used to find one or more characteristics of the data, and the data is then contextualised using a specific predefined ontology or ontologies. The specific ontologies are selected from predefined ontologies based on the characteristics of the data, found from the ETL processing, matching those associated with a particular ontology. Each of the specific ontologies is used by the ETL module to contextualise incoming data by providing a schema for storing the incoming data in a service delivery data base. Each of the specific ontologies is also used to synthesize an operational ontology which provides a schema in a knowledge graph providing a digital twin for the entity.

In some embodiments, the method validates that the operational ontology includes ontology fragments of specific ontologies where the ontology fragments are defined in accordance with a master ontology framework.

In some embodiments, the geo-spatial and temporal identifiers are included in the specific ontologies assigned to the data of each data classification to uniquely identify the data source of each data classification.

In some embodiments, the entity is a heterogeneous data source providing data having a plurality of different data classifications.

In some embodiments, at least one data classification comprises a process data classification.

In some embodiments, at least one data classification comprises an asset data classification.

In some embodiments, during the ETL processing, the characteristics of the received data are determined using a machine learning model classifier.

In some embodiments, during the ETL processing, the data is contextualised using one or more ontologies having characteristics which match the characteristics of the data determined using the machine learning model classifier.

In some embodiments, the data is contextualised into at least one data classification using the one or more ontologies.

In some embodiments, the geo-spatial and temporal identifiers from each specific ontology used to contextualise data from the entity uniquely identify that entity in the stored contextualised data.

In some embodiments, the operational and specific ontologies are re-definable specific ontologies used to contextualise another entity.

In some embodiments, the method further comprises: determining the data being processed by the ETL from the entity having characteristics which can be associated with at least one data classification similar to a data classification of characteristics of the other entity; obtaining a copied version of a specific ontology of the other entity for each similar data classification; and including the geo-spatial and/or temporal identifiers for the entity in the copied version of the specific ontology of the other entity to provide operational and specific ontologies for the entity.

In some embodiments, the synthesized operational ontology for the entity is synthesized using the redefined specific ontologies.

Other aspects are set out by the claims include an apparatus, system or control circuitry comprising means for one or more modules configured to perform a method according to any one of the above method aspects.

Advantageously, the digital twin is generated in a way which automatically recognises if an entity comprises different types of data sources, in other words, if an entity is a heterogeneous data source. Examples of heterogeneous data sources include at least one asset data classification and at least one process data classification, or a data source comprising two different asset data classifications.

Advantageously, identification of a data source type ensures a more seamless ETL process setup and increases the likelihood that the ETL will be able to ingest data for a given data source completely automatically as it allows, for example, machine learning based look-ups.

In some embodiments, the data from an entity is classified automatically during an extract transform load, ETL, process to establish a digital twin for the entity. This can allow a digital twin to be generated for an entity which comprises a large number of different types of data sources and/or component parts very quickly compared to conventional techniques, with build times being reduced to minutes or hours rather than weeks, months or years.

Advantageously, the specific ontologies which are used to contextualise data into a plurality of different types of data classification, for example, into process data classification(s) and/or asset data classification(s), are generated using ontology fragments, for example specific ontologies comprising logic pattern ontology fragments may be used. A master ontology provides a reference ontology for combining each ontology fragment to obtain an ontological schema for a particular digital twin. If a part of the entity is replaced or upgraded in the system, one or more relevant ontology fragments within the specific ontology for that part can be modified instead.

Advantageously, as the operational ontology for the digital twin of the system entity is synthesized from the specific ontologies for its constituent data sources, the operational ontology of the digital twin will also be automatically updated using one or more micro services.

Another aspect of the disclosed technology relates to a computer program product comprising computer code stored on a computer-readable medium, wherein the computer code is configured, when loaded from the computer-readable medium and executed by control circuitry comprising one or more processors or processing circuitry causes the control circuitry to perform steps of a method according to any method aspect disclosed herein.

Another aspect of the disclosed technology relates to an apparatus or control circuitry comprising means to perform any one of the above method aspects. The apparatus or control circuitry may comprise a system in some embodiments. In some embodiments, the means comprise control circuitry or a controller, memory and/or one or more processors or processing circuitry which are configured using computer code implemented as one or more hardware and/or software modules to implement any one of the disclosed method aspects.

In some embodiments, the control circuitry comprises the memory and/or at least one or more of the one or more processors and/or processing circuitry.

Some embodiments of the means comprise a memory module, at least one processor module or processing circuitry, and modular computer code stored in the memory module which, when executed by the at least one processor module or processing circuitry, causes the apparatus or processing circuitry to perform the steps of any one of the disclosed method embodiments.

In some embodiments, a machine executable computer-program product comprises machine-executable instructions which, when executed on the apparatus or control circuitry, causes the apparatus or control circuitry to perform the steps in any one of the disclosed method embodiments.

The machine-executable instructions may also be provided in the form of computer code modules which are stored in the memory module and/or processor module or processing circuitry in some embodiments of the apparatus.

Another aspect of the disclosed technology relates to an apparatus comprising: memory, an embodiment of the disclosed computer program product stored in the memory; and one or more processors or processing circuitry, wherein when the one or more processors or processing circuitry load the computer code from the memory an execute the computer code, the apparatus and/or processor circuitry is causes to implement any of the disclosed method embodiments.

Further preferred embodiments of the disclosure are defined in the accompanying claims. These and other features and advantages of the present disclosure will in the following be further clarified.

The disclosed aspects and preferred embodiments may be suitably combined with each other in any manner apparent to anyone of ordinary skill in the art, such that one or more features or embodiments disclosed in relation to one aspect may also be considered to be disclosed in relation to another aspect or embodiment of another aspect.

It is to be understood that the invention is disclosed by way of various example embodiments and is not intended limited to particular embodiments disclosed, but is defined by the scope of the accompanying independent claims and corresponding aspects, and by the preferred embodiments disclosed herein and by the corresponding dependent claims.

### BRIEF DESCRIPTION OF THE DRAWINGS

The above aspects, features and advantages of the disclosed technology, will be more fully appreciated by reference to the following illustrative and non-limiting detailed description of example embodiments of the present disclosure, when taken in conjunction with the accompanying drawings, in which:

FIG. 1 is a schematic illustration of a digital twin of an entity and the entity it represents;

FIG. 2 is a schematic illustration of a digital twin service system according to some embodiments of the disclosed technology;

FIG. 3 is a schematic illustration showing examples of ontology fragments according to some embodiments of the disclosed technology;

FIG. 4A is a schematic illustration showing examples of master, specific, and operational ontologies forming an example digital twin architecture according to an embodiment of the disclosed technology;

FIG. 4B shows schematically an example of a digital twin ontology constructed using ontology fragments according to some embodiments of the disclosed technology;

FIG. 4C shows schematically a specific example of a digital twin based on the digital twin ontology of FIG. 4B;

FIG. 5 is a schematic illustration of a method for contextualising data using a specific ontology

according to some embodiments of the disclosed technology;

FIG. 6 is a schematic illustration of a method for generating an operational ontology according to some embodiments of the disclosed technology;

FIG. 7 is a schematic illustration of another embodiment of the system of FIG. 2 suitable for building, storing and managing digital twins;

FIG. 8A is a schematic illustration of a method for contextualising, using one or more specific ontologies, data received from an entity according to some embodiments of the disclosed technology;

FIG. 8B is a schematic illustration of a method for processing a service request using a digital twin according to some embodiments of the disclosed technology; and

FIG. 9 is a block diagram illustrating an apparatus configured to host an embodiment of the system of FIG. 7 according to some embodiments of the disclosed technology.

### DETAILED DESCRIPTION

The present disclosure will now be described in detail with reference to the accompanying drawings, in which some example embodiments of the disclosed technology are shown. The disclosed technology may, however, be embodied in other forms and should not be construed as limited to the disclosed example embodiments. The disclosed example embodiments are provided to fully convey the scope of the disclosed technology to the skilled person. Those skilled in the art will appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs).

It will also be appreciated that when the present disclosure is described in terms of a method, it may also be embodied wholly or in part in apparatus comprising one or more processors, one or more memories coupled to the one or more processors, where computer code is loaded to implement the method. For example, the one or more memories store one or more computer programs that perform the steps, services and functions disclosed herein when executed by the one or more processors in some embodiments.

It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may refer to more than one unit in some contexts, and the like. Furthermore, the words “comprising”, “including”, “containing” do not exclude other elements or steps. It should be emphasized that the term “comprises/comprising” when used in this specification is taken to specify the presence of stated features, integers, steps, or components. It does not preclude the presence or addition of one or more other features, integers, steps, components, or groups thereof.

Some embodiments of method according to the first aspect of the invention will now be described, for example, a method of synthesizing an operational ontology for a digital twin of a real or virtual entity comprising at least one data source with reference to the accompanying drawings. In one embodiment, the method comprises: obtaining, using an extract transform load, ETL, system, data from the entity; as part of the ETL process, contextualising the obtained data using a plurality of specific ontologies, wherein each specific ontology comprises one or more ontology fragments forming a set of characteristics for a data classification of the data from the entity; for each specific ontology, using a representation of that specific ontology to contextualise a data classification of the data in a data store; and synthesizing an operational ontology for the entity using the plurality of specific ontologies.

The specific ontologies may comprise logic pattern ontology fragments in some embodiments. The term specific ontology may be built from one or more logic pattern ontologies and the term specific ontology may refer to one or more logic pattern ontology fragments accordingly. The term ontology fragment may also represent a reference to a logic pattern ontology fragment in the following description as will be apparent to someone of ordinary skill in the art from the specific context.

In some embodiments of the method of the first aspect of the disclosed technology the method is used to generate a digital twin representation of a real or virtual entity comprising at least one data source by additionally comprising: using a synthesized operational ontology to define a schema for a knowledge graph of the entity, and forming a digital twin for the entity by instantiating the operational ontology as an object in the knowledge graph which includes geo-spatial and temporal identifiers from each specific ontology from which the operational ontology was synthesized.

Some embodiments of the disclosed technology also relate to a computer-implemented method for providing a digital twin service to a requesting entity, the method comprising: receiving a request for service from the requesting entity; processing the request to determine one or more service characteristics; processing the service request using an operational ontology for the digital twin generated using the method of the first aspect; and providing the service to the requesting entity or to another entity identified in the service request.

In some embodiments, the above methods validate the operational ontology by checking the ontology fragments of the specific ontologies are defined in accordance with a master ontology.

In some embodiments, each specific ontology provides a classification for characteristics of the data generated by the entity. An entity is a heterogeneous source of data in some embodiments in the sense that it generates data which can be classified into multiple different classifications, for example, different asset or process data classifications.

In some embodiments, a data classification is defined by the specific ontology based on characteristics or a classification of the semantics or meaning of the data.

In some embodiments, an ontology fragment is a logic pattern which has several layers or levels of abstraction.

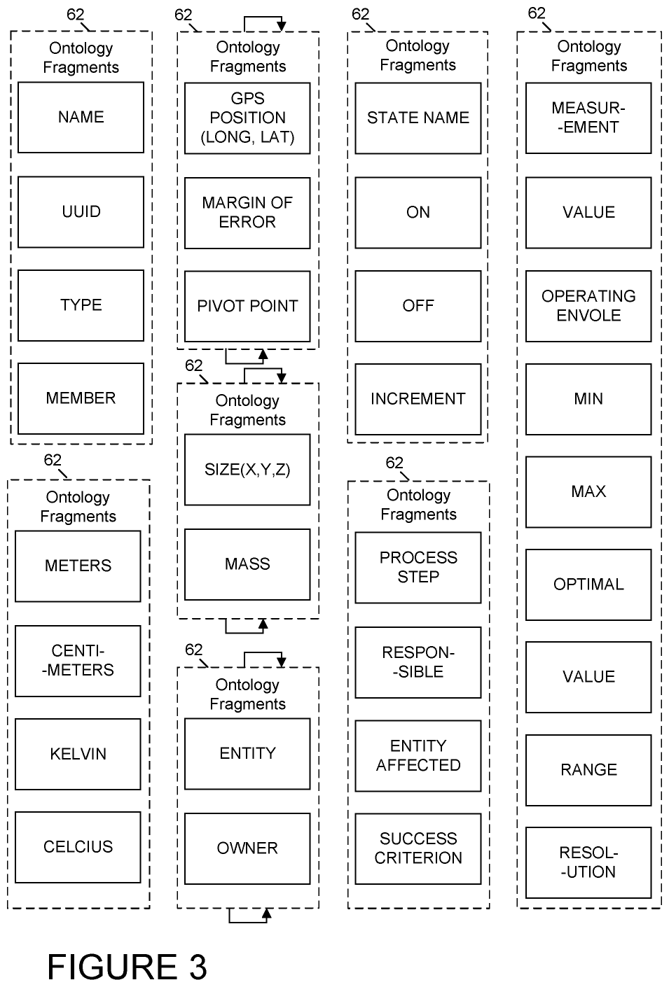

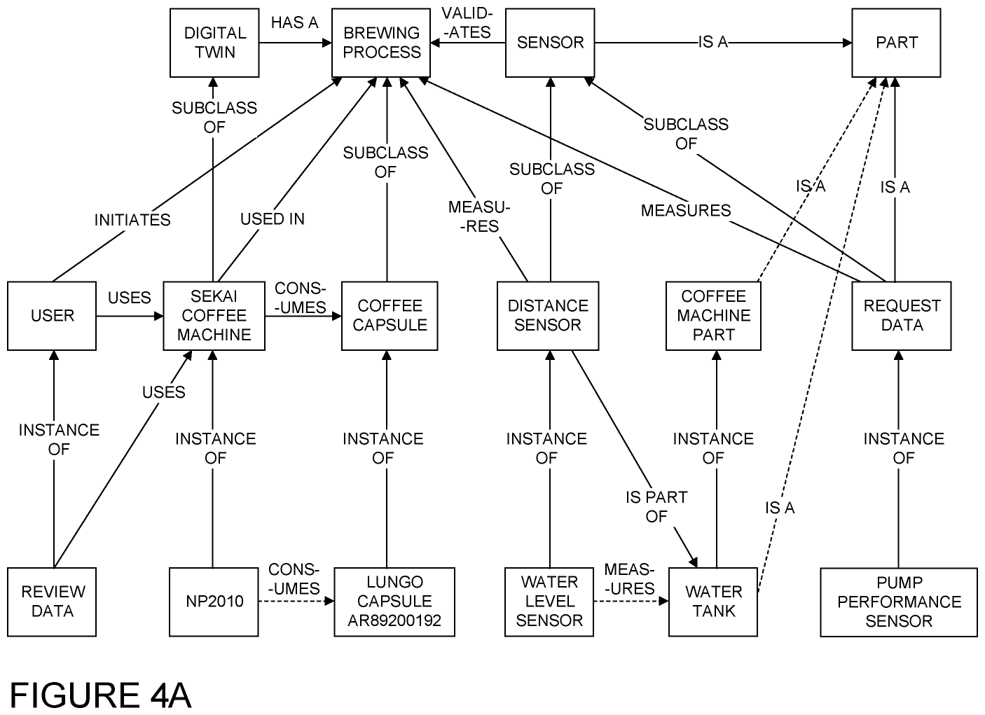

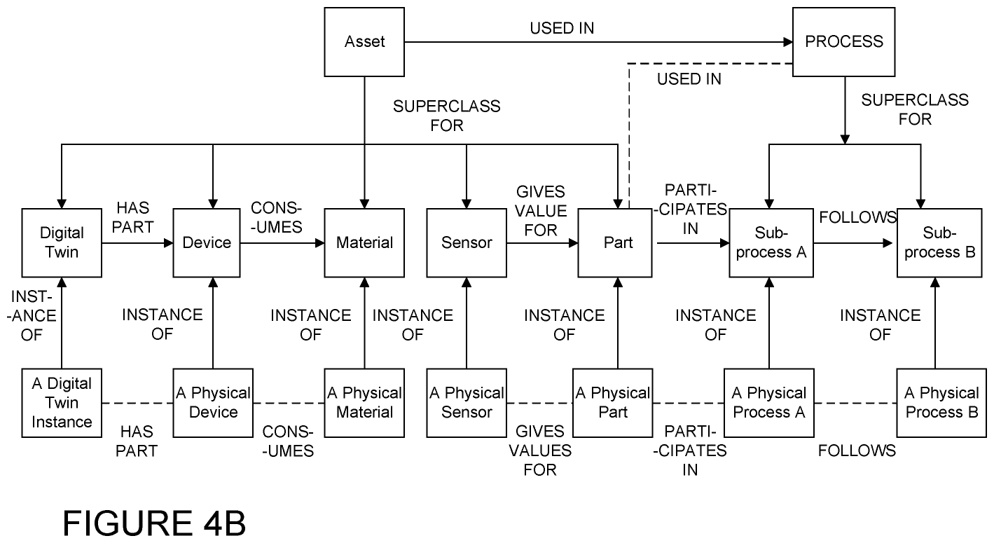

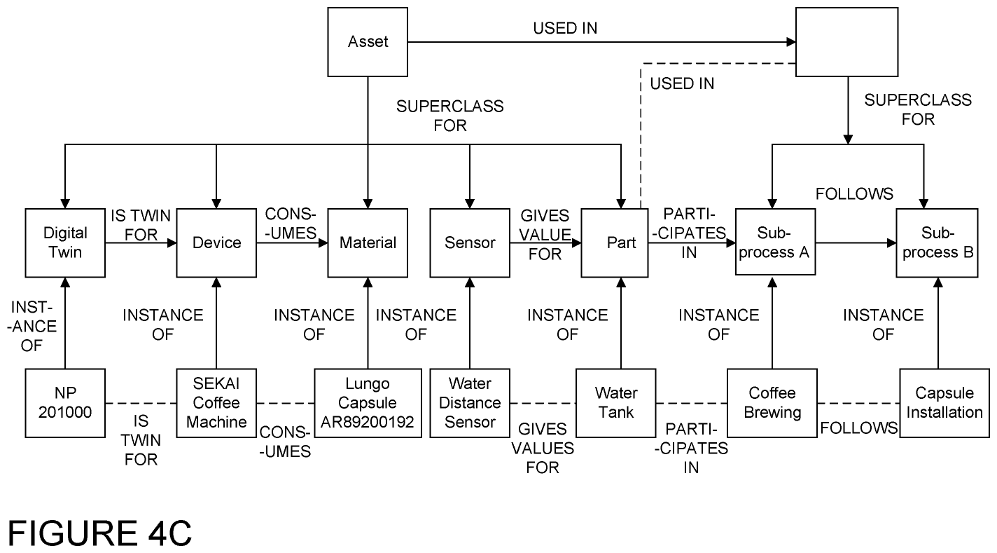

FIG. 3 shows some examples of ontology fragments 62. FIGS. 4A, 4B, and 4C show examples of the semantic layers which make up an ontology for a digital twin according to some embodiments of the disclosed technology. FIG. 4A shows the different sematic layers of an example ontology which may be built for a digital twin of a coffee making system as shown in FIGS. 4A-4C.

As shown in FIG. 4A, the digital twin is constructed from various specific ontologies comprising logic pattern ontology fragments for components of the coffee maker system. As shown in FIG. 4A, a coffee maker is presented by a digital twin which has a brewing process and is a subclass of a specific machine labelled in FIG. 4A “Sekai Coffee Machine”. A user is represented as well as an instance of review data which uses the Sekai Coffee Machine in FIG. 4A. The Sekai Coffee Machine is an instance of a model number, shown as the block labelled NP2010 in FIG. 4A, which consumes a type of coffee capsule, represented by the block labelled LUNGO CAPSULE AR89200192 in FIG. 4A, in other words, an instance of the coffee capsule is consumed by the Sekai Coffee Machine in FIG. 4A as part of the brewing process the coffee making system performs.

The user initiates a brewing process in FIG. 4A which uses the Sekai Coffee Machine. The consuming of the coffee capsule as a subclass of the brewing process. The brewing process the coffee making system performs is validated by a sensor shown as a part of the coffee making system of FIG. 4A.

The coffee making system shown in FIG. 4A also includes a distance sensor which is an instance of a water level sensor and part of which measures a water level in a water tank. The distance sensor is part of the water tank. A coffee machine part is a part and an instance of the water tank which is also a part. Finally, a pump performance sensor is shown as being part of the digital twin for the coffee making system of FIG. 4A. A data request is shown in FIG. 4A as instance of the pump performance sensor providing data, and the data request is also shown as a part of the coffee making system which is a subclass of the sensor which validates the brewing process and as a trigger for measuring the brewing process.

FIG. 4B shows a more detailed view of an abstraction of a digital twin architecture constructed from ontology fragments.

As shown in FIG. 4B, a system comprises an asset used in a process. The asset has a digital twin. A digital twin instance is a specific instance of the digital twin. The asset is a superclass for the digital twin, and also, in this example system, for a device of which the digital twin is part of, a material which the device consumes, a sensor which gives values for a part.

As shown in FIG. 4B, the digital twin has a part, shown as device in FIG. 4B. A physical device which is a part of the digital twin instance is an instance of the device. The device consumes material, however, the physical device consumes an instance of the physical material.

As shown in FIG. 4B, the asset is used in a process, which is a superclass for, in this example, two sub-processes A and B, where in this example, sub-process A follows sub-process B. Also shown in FIG. 4B is a sensor which gives values for a part, which participates in the sub-process A which follows sub-process B. In the example embodiment of a digital twin architecture shown in FIG. 4B, a physical sensor is an instance of the sensor, where the physical sensor gives values for a physical part which is an instance of the part which participates in sub-process A. The physical part participates in an instance of a physical process A which is an instance of the sub-process A. Physical process A follows physical process B, which is an instance of sub-process B.

FIG. 4C shows schematically how the digital twin example architecture shown in FIG. 4B can be similarly constructed as a digital twin for the coffee making system of FIG. 4A.

As shown in FIG. 4C, the lowest semantic level of the ontology shown in FIG. 4B is now replaced with the specific features for the coffee making system. So, for example, in the example embodiment shown in FIG. 4C, the instance of the digital twin shown in FIG. 4B is the model of the coffee-maker NP20100 which was also shown in FIG. 4A. In FIG. 4C the physical device which was an instance of a device as shown FIG. 4B is now the SEKAI coffee machine, the instance of the material shown in FIG. 4B is a Lung® ™ brand Capsule type (an example type being indicated by AR89200192 in FIG. 4C).

FIG. 4C also shows schematically that the water distance sensor of FIG. 4B is now an instance of the sensor, the water tank is an instance of the part of FIG. 4B, and the coffee brewing is an instance of sub-process A which follows the process of capsule installation, the physical process which is an instance of sub-process B.

The information and relationships which a digital twin ontology provides for a system according to the disclosed embodiments, is captured in the elastic knowledge graph for the system shown in the bottom level FIG. 4C. The left-hand side of the bottom level of FIG. 4C shows the elastic knowledge graph comprises logic pattern ontology fragments which are used to construct the ontology for the digital twin for the physical asset shown in FIG. 4C, where NP20100 is a digital twin for the Sekai coffee maker machine which uses the Lung® ™ brand capsule. The right-hand side bottom level of FIG. 4C shows schematically the elastic knowledge graph for the process shown in FIG. 4C, where the process ontology has been built from logic pattern ontology fragments representing various instances of the middle layer of semantic abstraction shown in FIG. 4B. The process EKG comprises a number of different logic pattern ontology fragments which represent, for example, instances of the parts and sub-processes used for the process of FIG. 4C. In other words, a logic pattern ontology fragment for the water distance sensor giving values for the water tank, for the water tank participating in coffee brewing, and for the coffee brewing following capsule installation may be used to construct the specific ontology for representing these components in the digital twin of the process.

FIGS. 4A to 4C accordingly show schematically how a digital twin can be constructed using abstract master ontology fragments at a top level, which encapsulated more specific ontologies comprising the ontology fragments at a middle level, and which are then instantiated in the knowledge graph of the digital twin as objects in the bottom level. In other words, an ontology fragment may be for any type of sensor, but more detail is added by a ontology fragment for temperature, the output of the two ontology fragments in combination is a specific ontology for a temperature sensor. The specific ontology includes the sensor classification information and the specific information for temperature.

In some embodiments, the master ontology accordingly provides a level of abstraction, ontologies for elements, objects, entities, events, processes, “social objects”, measurements, etc. which form an abstract knowledge domain using independent terms. The specific ontologies are domain specific, and define a class of something represented at the master ontology level. As a n example a domain specific ontology may still be for a generic type of object, for example, a “sensor” is a class of physical object with these properties and roles. The specific ontology also includes added specification information, for example, a sensor that has x and y properties is labelled a temperature sensor. Temperature is not in the master ontology.

In some embodiments, synthesising an operational ontology provides a schema in a knowledge graph for a digital twin which contains parts etc. and processes for those parts. The ontology fragments of each specific ontology are combined and all components and relationships are preserved from each separate ontology fragment. A hierarchy of structure used in each ontology fragment is dictated by the master ontology acting as a root ontology in some embodiments. There remains, in some embodiments, a need to validate that the logic of the statements of each operational ontology is in accordance with the logic of the statements of the master ontology, as the specific ontologies used to synthesize the operational ontology may contain statements which, when combined conflict with each other, and/or with the master ontology.

In some embodiments, the operational ontology is an operational ontology which provides a data schema for a knowledge graph. The operational ontology may be a dynamic operational ontology in some embodiments if it is updated through the life-cycle of the knowledge graph.

In some embodiments, a knowledge graph is a labelled property graph database that stores knowledge based on a graph mathematical model and which includes a reference catalogue to all data storages in the system used to store data from the entity and/or to provide services using the digital twin for the entity. In other words, a knowledge graph has necessary information about what data is stored where in the system.

In some embodiments, a federation service is used. This may be optional in some embodiments.

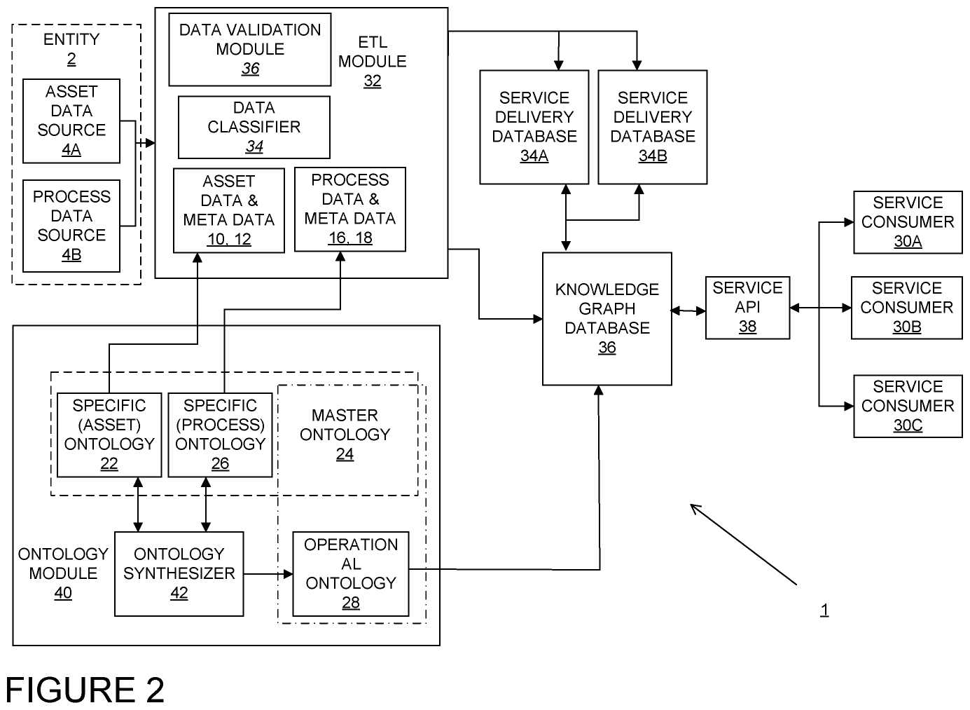

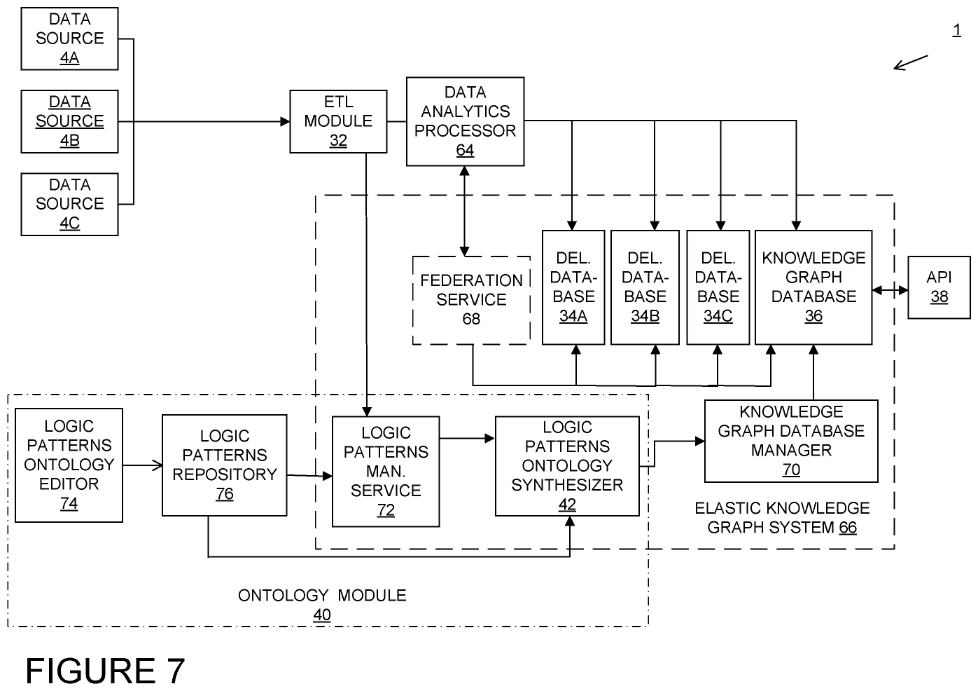

The federation service federates each service delivery data base, such as databases 34 shown in FIGS. 2 and 7, with the knowledge graph to generate a so-called elastic knowledge graph, EKG, for example, through the use of the micro-services shown as 42, 68, 70 and 72 in FIG. 7 which is described in more detail later on. The reference data to locate the relevant data from the entity in some embodiments uses federated data and metadata storage provided by the federation service module 68 shown in FIG. 7 (which is federated as it gets multiple kinds of information from different sources).

The term elastic knowledge graph refers to a knowledge graph which is flexible in the sense that a data schema is not static for each digital twin record in the knowledge graph database. The elastic knowledge graph or EKG in some embodiments reflects the history and life-cycle of each digital twin.

In some embodiments, multiple digital twins are provided in one graph database. In some embodiments, each digital twin has its own elastic knowledge graph. In some embodiments, the operational ontology which is synthesized from the specific ontologies used to contextualise data received from an entity as the data is being processed by the ETL module is a schema for the knowledge graph of that digital twin of that entity.

The delivery databases, 34, comprise any suitable form of data storage device and can provide data for purposes other than providing a service to a requesting entity via the API 38 shown in FIG. 2 and described later in some embodiments. The ETL module 32 processes input data from entity 2 and outputs the data classifications that the specific ontologies have contextualised the data into to the service database(s) 34 and also populates the knowledge graph via the federated service module 68 shown in FIG. 2. This information is provided as a reference service in the ETL process; the reference service may in some embodiments be used as a trigger for new reference data to appear in the EKG. An example EKG is shown in FIG. 4C at the bottom level.

The ETL module 32 takes data input which is obtained from an entity 2, and contextualises the input using one or more specific ontologies. Each ontology individually and/or, in some embodiments, collectively defines the schema for storing the data from that entity 2 in a delivery database 34.

In some embodiments, the output of ETL module 32 comprises data which is output as data for storing to the delivery databases or data stores 34A, B, C D shown in FIG. 2. The output data is stored in the delivery database using the schema defined by the specific ontology using to contextualise that input data.

In some embodiments, the output of the ETL also comprises metadata to populate the knowledge graph, KG, or elastic KG, EKG, of knowledge graph database 36. The KG, or EKG, stores metadata from both the specific ontology and/or metadata from a data provider/data source or metadata from the ETL module 32 which provides information and/or provides instruction about how to obtain the data from the data source and/or an identifier or label for the data source about the data source and reference data which is used to look up the relevant data feed readings of the sensor in the delivery database 34. For example, if a data source of an entity is a sensor, then the data feed readings of the sensor will go to, for example, delivery database 34A. The static information about that sensor, for example, its manufacture/operational knowledge may be stored in the EKG, or another service delivery database 34B.

In some embodiments, the output of the ETL also provides references in the KG, or EKG, 36 to the data or metadata for the data source of that data in a service delivery database 34. The metadata for a data source is updated by the ETL process each time data is received from that source, meaning that references which indicate where/how the data is stored in a delivery data store 34 can be obtained and queried from the KG, or EKG, database 36. This means that in the case where data is being streamed from a data source of an entity, the ETL module 32 will need to constantly generate references to each instance of the data from the data stream. These references are stored in the KG database 36.

The result of the ontology synthesis is an operational ontology. The operational ontology is a schema which is instantiated for each specific entity, e.g. each sensor of that type of sensor. If a sensor is the nth+1 sensor and there are no previous sensors, then the same operational ontology and schema is reused in the EKG with a new instantiation. If the sensor is a new sensor, e.g. a humidity sensor, then the output of the ETL is stored in one or more delivery databases using a schema based on the logic pattern that was used in the ETL process to contextualize the humidity data. This also triggers the new logic pattern ontology fragment to be added to the logic pattern ontology fragments used to synthesize a new operational ontology and this is then used to generate a new schema for the EKG for the entity with the humidity sensor.

The disclosed embodiments accordingly allow data to be stored in a form in which the data is not prepared in advance to address a potential set of queries. In other words, the data is restructured in accordance with logic pattern specific ontology fragments so that it supports various queries over the data.

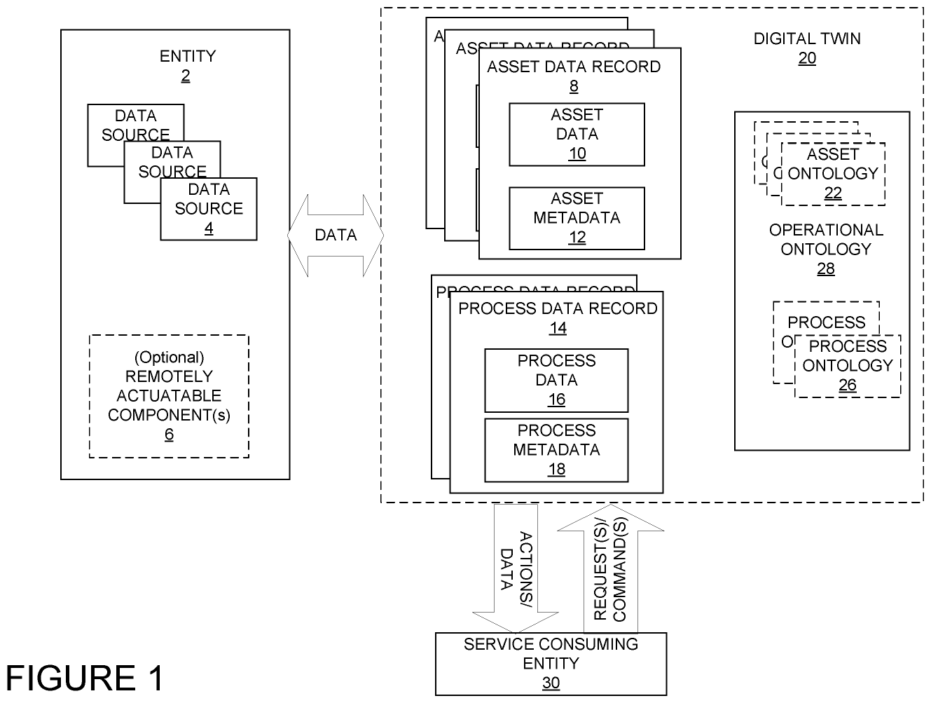

FIG. 1 is a schematic illustration of an example embodiment for an entity 2 and its digital twin 20. Entity 2 may be a real or virtual entity 2. In the example embodiment shown in FIG. 1, the entity 2 comprises a plurality of data sources 4 and/or remotely actuatable components 6, which provide data and this data is also represented in the digital twin 20. In some embodiments, entity 2 comprises a plurality of heterogeneous data sources 4, for example, different classifications of data may be generated using different data sources. This is exemplified in FIG. 1 by showing entity 2 comprising at least one data source 4 which is providing asset data and another of the data sources 4 may provide process data.

Asset data in some embodiments represents semi-persistent data for the entity, such as the state of the data source of the entity. Examples include the location of the data source in the entity and/or the location of the entity at a particular point in time. If the location of the entity moves, however, the asset data is dynamically updated.

Process data in some embodiments represents data sent by a data source, which may or may not be generated by that data source, of the entity which is dynamic and changes responsive to an operation being performed by the data source and/or the state of the data source. For example, a sensor provides a data feed comprising values and time-stamps for the values which represent some sensed measurement of the environment of the sensor. The data feed is time-series data and may or may not provide process data depending on the way the data is generated.

Examples of real entities include systems, machines, and devices, as well as their sub-systems and individual components, as well as application programming interfaces and database integrations etc. Examples of virtual entities which may have digital twin counterparts include on-line financial transactions and processes, and also logistics, and database entities. As an example of a real entity, consider a valve system which comprises a valve and at least one fluid flow sensor for its outlet pipe and at least one temperature sensor for its inlet pipe. The fluid-flow sensor is a source of fluid flow process related data and asset data for that flow sensor, the temperature sensor is a source of fluid temperature process data and asset data for the temperature sensor, and the valve is a source of asset state data.

The example embodiment of the digital twin 20 in FIG. 1 comprises a plurality of asset data records 8 and, in this example, process data records 14. It should be appreciated, however, that some embodiments of a digital twin 20 could contain only one type of process and/or asset records. In some embodiments, each digital twin comprises an instantiation of schema which an operational ontology defines in a knowledge graph for the entity.

In the example embodiment of FIG. 1, each type of asset data record 8 comprises asset data 10, for example, a data feed, and metadata 12 for the asset data 10. A specific ontology is used to contextualise the data which provides a schema specifically assigned for storing that specific type or classification of data, in this example, the specific type of asset data 10 of that entity 2 in a database or data store from which it can be associated with the digital twin of the entity, such as, for example, one of the delivery databases or data stores shown in FIG. 2 or 7 as service delivery databases 34A, 34B, or 34C for example.

The specific ontology metadata 12 provides information about one or more characteristics of a particular classification of the data and/or the data source and includes at least an ontology for geo-spatial and temporal information about the data classification, such as the asset data classification 10 or process data classification 16 and/or about the asset or process data sources 4A and 4B.

The geo-spatial information may be iteratively updated and may be provided in a form which is relative to the location of other entities/asset data sources. For example, in some embodiments, a location could be indicated for a particular asset data source 4 using a CAD drawing reference system for entity 2. Entity 2 could also be indicated using a system diagram within a larger more complex system of similar or different entities. That complex system example could be provided with floor and room location information in a building, and where that building is in GPS or latitude/longitude co-ordinates finally provided.

Each type of process data record 14 comprises process data 16 and metadata 18 for the asset data 10. The process metadata 12 includes, for example, an ontology for the process data. The process ontology metadata is information about characteristics of the process data.

The ontology may in some embodiments only provide metadata for the process data from entity 2, as asset data for entity 2 is provided with a different ontology.

Alternatively, or in addition, in some embodiments, it is also possible for each data source of process data to be contextualised using a specific process data ontology which also includes at least geo-spatial and temporal information about the process data source 4. A process is not something isolated from assets that participate in the process, so that data can be linked initially.

The digital twin of FIG. 1 also comprises an object instantiation of an operational ontology 28 which is synthesized from the asset and process specific ontology fragments, for example, logic pattern ontology fragments, also referred to herein as logic patterns of each asset data source and each process data source of a real entity. The specific ontologies may comprise predefined specific ontologies including ontology fragments which are predefined and created in advance in some embodiments. The specific ontologies are synthesized, for example, assembled or put together, to form an operational ontology, for example, based on their connections to a master ontology. The master ontology does not necessarily include those fragments as this would make it too big, they are effectively encapsulated at a more abstract level within the master ontology which is used as a reference and guidance, and for consistency verification for the process of combining fragments into an operational ontology.

The specific asset and process ontologies 22, 26, and operational ontology 28 are generated using fragments which should comply with the ontology framework of the same master ontology 24 (see FIG. 2, described later below, and the example of FIG. 3 described above).

By providing an operational ontology which defines a schema for a digital twin in some embodiments, services can be provided to one or more service requesting entities 30. As shown in FIG. 1, the digital twin 20 may provide services to one or more service requesting entities 30 using a knowledge graph for the entity 2 for which the schema is defined using an operational ontology 28 synthesized from the specific ontologies used to contextualise the data from the entity. As shown in the schematic example of FIG. 1, a service consuming entity 30 is able to generate requests, queries or commands which the digital twin 20 is used to fulfil.

For example, a service consuming entity 30 can receive a data feed from a real entity 2 such as a sensor by generating a request for the data feed which is sent to the digital twin 20. The operational ontology of the digital twin 20 defines what operations are available through the digital twin which use the relevant asset and process data, and also enables access to the relevant asset data record for that sensor, and then uses this to determine the relevant process data record to configure the entity 2 to send its sensor data to the service consuming entity 30.

As another simplified example, consider a digital twin 20 for a valve system 2, where the valve system comprises a valve 6 that can be remotely activated, and a sensor 4A for the fluid flow through an inlet pipe to the valve 6 and a sensor 4B for the temperature of the fluid in the inlet pipe. The valve system 2 is configured to export the data feeds from each sensor 4A, 4B, data for the valve state, and provides remote access to control the state of the valve.

To generate a digital twin for the valve state, a computer-implemented method for generating a digital twin representation of a real or virtual entity comprising at least one data source as disclosed herein is performed, in which in this simplified example, the digital twin represents the valve system. The method comprises first storing data such as, for example, the data feeds and state data, from at least one data source, for example, the sensors and the valve, of the entity, for example, the valve system, in a suitable data store referred to herein as a service delivery data store. Specific ontologies are then used to contextualise each type or classification of data, for example, the asset data classification(s) or process data classification(s), received from the entity which are held in a data store such as the service delivery data stores 34A, 34B shown in FIG. 2 or as data stores 34A, 34B, 34C shown in FIG. 7.

For example, a specific ontology is selected or otherwise assigned or determined to be suitable to contextualise the fluid-flow sensor data feed to indicate what the data is (a fluid flow measurement, and what unit of measurement is provided, and any other characteristics of the data feed itself) and one or more characteristics of the source of that data, for example that the source is a fluid flow sensor. Each specific ontology will also include unique geo-spatial and temporal identifiers for each source of data or the entity. This allows the location of the specific data source in the entity to be known in the digital twin for the entity. For example, where the sensor is located in the valve system could be indicated using a CAD diagram and reference coordinates, and the location of the valve may also be provided using latitude and longitude.

In some embodiments, an operational ontology provides a schema for a knowledge graph of the entity which reflects the various data classifications associated with characteristics of the data that were used to determine what specific ontologies contextualised the data from the entity. In other words, a digital twin for the valve system is then generated using an operational ontology based on the ontologies assigned to each specific data source, here the fluid flow and temperature sensors and the valve.

The specific and operational ontologies which are used when forming a digital twin for an entity are, in some embodiments, provided using a method for dynamically generating an ontology for a digital twin counterpart of a real or virtual entity according to the first aspect. In some embodiments, the method uses a plurality of specific ontologies to synthesize an operational ontology in which each specific ontology is used to assign a class to a data source. This may be performed manually but is preferably performed using a computer, for example, an AI system may be configured to classify the data the ETL has received into data from the fluid flow sensor, data from the temperature sensor, and data from the valve. Not all data may be sensed initially at the same time. The amount of time to collect sufficient data by the ETL system to classify the data correctly into asset and process data classifications may differ for different entities.

The method then assigns a schema for storing each type of data classification, which is based on a specific ontology for that data classification. Each specific ontology comprises a validated sub-set of ontology fragments which comply with more abstract ontology definitions within which that ontology falls taken from a higher level of an ontology framework, for example, from a master ontology framework. For example, in some embodiments, the method contextualises each process or asset data classification using a specific process or asset ontology for data having a set of one or more characteristics defining that data classification. Each specific ontology comprises a validated sub-set of logic pattern ontology fragments.

The specific ontologies are manually created or may be generated using a computer and are predefined. For example, in some embodiments, a specific ontology is manually defined using an ontology editor, which may also be referred to herein as a logic pattern ontology editor 74 such as that shown in FIG. 7 and described in more detail later below and then stored in an ontology repository, for example, logic pattern ontology repository 76.

Each specific ontology comprises a number of fragment ontologies and in some embodiments, at least one of the specific ontologies is based on another specific ontology by replacing at least the geo-spatial and temporal identifiers of that ontology with identifiers for the specific data source it is to be assigned to. The specific ontology, in other words, the logic pattern ontology fragment, is used to contextualise the relevant classification of data from the entity 2 in a data store, and to synthesize an operational ontology. This is then used to define a schema in a knowledge graph from which an object can be instantiated as a digital twin for the entity. The instantiation of the operational ontology includes geo-spatial and temporal identifiers from each specific ontology from which it was synthesized.

The operational ontology synthesizing process accordingly enables a digital twin for the operation of a system, such as the valve system, to be established in a way which allows a component of the system, in other words one of the sensors or the valve, to be replaced without having to rebuild the entire ontology for the operation of the valve system, as it is possible to just replace the fragment of one of the specific ontologies used, such as the geospatial and temporal identifier, if the sensor is moved, and to replace another fragment of the specific ontology if, for example, a different sensor is used instead of that sensor.

There are various definitions of the term ontology used herein which are to be considered as complementing each other rather than being exclusive definitions. In some contexts, an ontology can be considered to refer to a formal, explicit description of the concepts in the particular domain of each digital twin, properties of each concept describing various features and attributes of the concept (which may be referred to as roles or properties), and restrictions on those various features and attributes. A more detailed description of an ontology is that it represents what is relevant to a particular domain or area of interest, and as such may specify terminology, concepts, nomenclature, relationships among and between concepts and individuals, and semantic expressions which distinguish concepts, refine definitions and relationships in the form of constraints and restrictions.

FIG. 2 shows in more detail a system 1 for creating a digital twin 20 of an entity 2 according to some embodiments of the disclosed technology. In FIG. 2, entity 2 is a heterogeneous data source as it comprises at least one asset data source 4A and at least one process data source 4B. For clarity, in the illustrated example embodiment of FIG. 2, only one asset data source 4A and one process data source 4B of entity 2 are shown. In FIG. 2, elements which are labelled or refer to specific ontologies comprise one or more logic pattern ontology fragment.

By way of example only, consider an example embodiment of an entity 2 which comprises a valve system. The valve system comprises various sensors and a valve and each sensor are separate data sources. In some embodiments, each data source 4A, 4B uses an ontology which can exist independently from the ontology used for the valve system. In other embodiments, the digital twin of each data source 4A and 4B is represented by the ontology used for the digital twin of the valve system 2.

In some embodiments, the classification conditions for a data source to be considered an asset data source or a process data source is context specific. For example, in some embodiments, a sensor may provide information about its location, what it does, and its operating state (switched on/off) which forms asset data. The data feed each sensor generates by the operation the sensor performs, in other words, sensing its environment in some way, may form process data. An entity which is virtual and only exists in the context of a particular data feed which is generated or synthesized in some manner, for example, from a cloud computing source, may conceivable be considered to comprise only process data. Virtual data can also provide asset data in some embodiments.

In the context of the valve system example embodiment, the valve system is a heterogeneous data source for asset and process data. Each sensor is also a heterogeneous data source for asset and process data. The valve provides only asset information about its location and state (on/off). It may also be possible in some embodiments for a data source to only provide process data but if the location of the process data source is to be provided, this would then be considered asset data.

In FIG. 2, the system 1 comprises an extract transform load, ETL, module 32 which is shown in this schematic example as receiving data from two data sources 4A, 4B. The ETL module extracts data from external, in other words remote, entities comprising one or more data sources, into the system 1 which represents the entities and/or their data sources in a manner that allows services to be offered involving operations which are performed by or on or involve the entities and/or one or more of their data sources. The ETL model 32 shown in FIG. 1 extracts data 10, 14 from the data sources 4A, 4B of entity 2, transforms the data to form service data which allows a service to be provided utilising the data or data associated with or derived from the data, and stores the service data in one or more delivery databases 34A, 34B.

In the embodiment shown in FIG. 2, the ETL module 32 comprises a data classifier 34, for example, a suitably trained machine learning model which classifies the data received from the data sources 4A, 4B of entity 2 into asset data 10 and process data 16. The data which is classified by the classifier 34 as asset data 10 is then associated with asset metadata 12 for that type of asset using an asset specific ontology 22. The data which is classified by the classifier 34 as process data 10 is then associated with process metadata 18 using a process specific ontology 26. The asset and process specific ontologies 22, 26 are provided by an ontology module 40, for example, by the system 1 performing a method according to the first aspect disclosed herein or any of the embodiments of those aspects.

In some embodiments an ontology fragment is reusable and functions as a building block for organizing any kind of physical or virtual structure. The ontology fragment may represent a purpose, a goal, or an intended use of the object. An ontology in the present disclosure can be considered to define a data schema, in other words a canonical schema which allows data to be mapped from diverse different sources and types of sources to a form which allows the meaning of the data to be managed consistently. The method uses specific ontologies constructed from ontology fragments which provide specific schemas to contextualise different classifications of data from an entity and uses the same specific ontologies to synthesize an operational ontology for defining a schema for a digital twin of the entity. The use of a master ontology to provide a framework for the ontology fragments in some embodiments allow the efficient reuse of ontology fragments for forming specific ontologies for a variety of different types of data sources and use context. This means it is possible to quickly generate digital twins in a flexible and scalable way which is far more computationally and time resource efficient than other techniques known to someone of ordinary skill in the manner.

Turning briefly to FIG. 3, this shows schematically some examples of ontology fragments 62 which are represented in a more abstract form within a master ontology 24. In the examples shown schematically in FIG. 3, ontology fragments 62 are organised into different categories or classes of ontologies, however, many other possible ontology organisational structures including hierarchical structures of ontology categories and ontology fragments are possible as would be apparent to someone of ordinary skill in the art. For example, ontology fragments could belong to an ontology fragment category associated with temperature, ontology fragments could belong to an ontology fragment category associated with asset type, for example, a model or version of a particular type of asset, which may represent an address in some embodiments such as a MAC or IP address. A digital twin for a building or smart city or a shipping system or other set intensive object may have far too many parts to model with a static ontology model. For example, of the order of tens of thousands or more components in an entity could result in a knowledge graph or EKG which has billions of nodes. A DT for an entire country has far more. Accordingly, the ontology fragments used to build specific ontologies are reusable as much as possible and the fragments can be categorised with this reusability goal in mind.

Some ontology fragments for example, may comprise geospatial/temporal fragments which are associated with position and date or timestamp formats. Some ontology fragments may be examples of process fragments for actions and may label an action (turn on/turn off), or f or example, a temperature sensor comprises asset data and process data. For example, some examples of temperature ontology fragments may provide metadata which provides contextual information about the data 10, 14 generated by a data source, for example, that the data is “temperature” data, and also provide a measurement unit for that data, for example, “Kelvin” to indicate any numeric data is representing a temperature measured in Kelvin (and not, say, Celsius). These ontology fragments contribute to the specific ontology for the temperature sensor of the valve system example, and form part of the metadata 18 associated with the temperature data feed 14 from the temperature sensor 4B (for example). Some examples of geospatial/temporal ontology fragments provide positional information, such as, for example, the latitude/longitude of the valve system the temperature sensor is part of, and also when the sensor was installed, for example, month/day/year. Time-stamp information may also be provided along with positional information for the process data 14. In complex systems, the internal location of the temperature sensor may also be provided using an ontology to allow this internal location to be understood.

Ontology fragments 62D relate to actions in the example shown in FIG. 3. As each asset or data feed specific ontology can be built up from a plurality of ontology fragments as shown, other ontologies which are synthesized from the same fragments will be compatible with the specific ontologies. This can allow, for example, parts of an entity to be replaced and/or upgraded and for the ontology of the original part to be reused and for any operational or other types of ontologies synthesized from that replaced part ontology to remain compatible with the new parts ontology. This allows for faster and more reliable digital twins to become operational far sooner than would be the case if the operational ontology of a digital twin had to be rebuilt every time a part was upgraded or replaced with a part which had different characteristics and/or otherwise required a new ontology.

Accordingly, it will be clear to anyone of ordinary skill in the art that an entity such as a valve system may comprise multiple smaller entities and make up a component itself in a larger entity. The ontologies to describe each system however are compatible as they each are made up from reusable and/or re-definable ontology fragments 24.

As shown in FIG. 2, entity 2 is a source of two types of data, one type is characterised as asset data 10 by the ETL module 32 and the other type is characterised as process data 16. The asset data 10 is contextualised whilst it is being processed by the ETL module 32 using a specific asset ontology 22 which provides schema for storing that asset data and its metadata 14 in a delivery database, for example, database 34a shown in FIG. 2. The process data 16 is contextualised whilst it is being processed by the ETL module 32 using a specific process ontology 26 which provides schema for storing that process data 16 in a delivery database, for example, database 34b shown in FIG. 2 along with its metadata 18.

FIG. 2 also shows how the asset and process ontologies 22 and 26 are also used to generate an operational ontology 28 using an ontology synthesizer 42 of the ontology module. First order logic is used to validate that the operational ontology also complies with the more abstract ontologies that the specific ontology fragments were checked for compliance with in some embodiments. The ontologies are statements written in a specific formal language in some embodiments, first order logic. This language has its syntax. Each ontology can be seen as a text created in this language. When the specific ontologies are synthesized, for example, by integrating or combining specific ontologies, the statements written in each text ontology must be checked to confirm that the statements are not conflicting with the statements from any of the other ontologies being combined. In other words, ‘thing is sphere’ in one ontology would conflict with ‘thing is cube’ from another. The checking or validation is done in some embodiments, using a set of algorithms performed over those statements (which are written in first order logic language). In some embodiments, the algorithms are used to verify if the statements in the specific ontologies are not in conflict with the statements defined at a more abstract level in the master ontology which is a framework or foundational ontology which describes the most generic, domain independent entities, processes and relations among them.

The operational ontology 28 which generated by synthesizing specific ontologies 22, 26 associated with the asset and process data sources is accordingly also formed of a plurality of ontology fragments 62 which, in some embodiments, form specific ontologies based on a mathematical model such as descriptive logic for example, first-order logic. In the system operational ontologies are transformed based on this math model to another math model—labelled property graph (LPG).

The operational ontology is used as a data schema for the knowledge graph (KG) of the digital twin, which is an elastic KG in the sense that the data schemas may change dynamically. The knowledge graph is a database for storing data, instances of the digital twin. This database is based on another math model, the labelled property graph, LPG. Some embodiments use a mechanism of creating, and populating an EKG database in accordance to an ontological data schema defined by the operational ontology. FIG. 4C shows schematically an examples of elastic knowledge graphs along the bottom level of the digital twins for the asset and process digital twins shown in FIG. 4C.

In some embodiments, each knowledge graph for a digital twin is preferably an elastic knowledge graph which contains not only static view on the entity the digital twin represents but also keeps a record of dynamic changes happening to the entity over time by maintaining references to historical state and related data stream information for the entity.

The knowledge graph data base 36 will normally store a plurality of objects each instantiating an operational ontology 28 synthesized from the specific ontologies 22, 26 which were used to generate ontology metadata for each data source 4A, 4B of an entity 2. Each operational ontology 28 will be associated with a particular entity 2 and a particular entity 2 is associated with a particular operational ontology. Thus the objects which are instantiated in the knowledge graph data base 36 may be considered to comprise part of the same digital twin representation of the entity 2 as the data and specific ontology metadata for the diverse data sources of the entity 2 in the embodiment shown in FIG. 2.

In some embodiments, the entity 2 comprise a plurality of data sources which transmit raw data relating to at least one physical asset and/or process to the ETL module 32.

In some embodiments, a digital twin for an entity which is not operational may initially be just an asset data source, for example, provide state information for the entity such as its location, when it was installed, and what type of asset the entity is. Later, the entity may be turned on and become operational, and at this point the system also enables the digital twin to automatically sense that the entity is now represented by two heterogeneous data sources in the sense that in addition to data representing the state of the entity as an asset or thing (asset data) and a data feed is also being generated by the entity to represent what the asset or thing does (process data).

In some embodiments, at least one of the plurality of data sources comprises a web-service data source, data from an application programming interface, a sensor, an IoT device or system or component of such a device or system, or an external database.

Thus system 1 as shown in FIG. 2 can be used to implement a method according to the first aspect of the disclosed technology in which a computer-implemented method dynamically synthesizes or generates an operational ontology which can be used to define a schema for a knowledge graph representing a digital twin 20 of entity 2 For example, in some embodiments, the system 1 can be used to implement a method comprising receiving data from at least one asset data source 4 and/or at least one process data source 6 associated with the entity 2. The method comprises determining characteristics for classifying the received data 4A, 4B, as process data 14 if the received data relates to a process and/or asset data 10 if the received data relates to an asset. For received data having characteristics for an asset data classification, the method may further comprise generating asset metadata 12. The method also comprises using an asset specific ontology 22 to contextual the data having the asset data classification by providing a schema for storing the asset data 10 and the asset metadata 12 in a data record 8 for the asset which may be stored in a delivery database 34.

For received data which has characteristics that could be classified as process data characteristics, the method comprises generating process metadata 18 and using a process specific ontology 26 comprising one or more process ontology fragments associated with the process data characteristics to contextualise the receive data and metadata using a schema for a process data classification. The process data 16 and process metadata 18 are then stored using that specific process ontology schema in another type of data record (shown as data record 14 in FIG. 1).

The method of the first aspect in some embodiments synthesizes an operational ontology 28 for the digital twin 20 of the entity 2 using one or more data classification specific ontologies such as the process specific ontologies 26 asset specific ontologies 22 shown in FIG. 2.

Optionally the conformance of the process and/or asset and operational ontologies may be then validated in some embodiments. The validation may be automated or performed manually, for example, data validation module 26 may form part of the ETL module 32 which includes a user interface to allow manual validation of the specific and/or operational ontologies in some embodiments. The classifications and/or the metadata for the specific asset/process data are accordingly capable of being manually validated by a data validation process in some embodiments of the disclosed technology.

The ontologies 22, 26, and 28 are according generated by the method of the first aspect are capable of being used in a method for generating a digital twin representation of a real or virtual entity comprising at least one data source comprising: using a synthesized operational ontology to define a schema for a knowledge graph of the entity, and forming a digital twin for the entity by instantiating the operational ontology as an object in the knowledge graph which includes geo-spatial and temporal identifiers from each specific ontology from which the operational ontology was synthesized.

The ontologies may also be used to provide an EKG for a digital twin, from which a digital twin service may be provided to a requesting entity, the method comprising: receiving a request for service from the requesting entity; processing the request to determine one or more service characteristics; processing the service request using a knowledge graph or EKG schema which uses an operational ontology for the digital twin generated using the method of the second aspect; and providing the service to the requesting entity or to another entity identified in the service request.

The method according to the first aspect of the disclosed technology in some embodiments further comprises associating the process data 16 and/or process metadata 18 and/or associating the asset metadata 12 and asset data 10 with the instantiated object of the digital twin 20 in a data store 34A, 34B accessible to the elastic knowledge graph 36.

FIG. 2 also shows schematically how a variety of digital twin service consumers 30A, 30B, 30C may access the digital twin data via an application programming interface 38 to the knowledge graph data-base. Examples of service consumers 30A, 30B, 30C, include other computational devices such as mobile computers, tablets, smart-phones, brain-computer interface devices, personal computers and servers, and other entities, which may also have their own digital twin represented in system 1.

Although in many embodiments the entity 2 is a real entity, in some embodiments, it may be a virtual entity such as a mortgage application or similar transaction and/or a logistics feed or process for example, may be represented by a digital twin in the system 1.

In some embodiments, classifying the received data is performed using a machine learning model classifier such as that shown as data classifier 34 in FIG. 2. Any suitable classification ML model may be used as would be apparent to someone of ordinary skill in the art for which training can be supervised based on historic examples of data classifications.

The asset ontology and the process ontology are based on a master ontology framework in which

a specific ontology specifies a fragment from the master ontology and does not just comprises those ontology fragments. So say, a fragment ‘physical object’ is taken from the master ontology, then this has a subclass vehicle, with has specific properties, relations, etc. in such a way a specific ontology of vehicle is obtained, based on the master ontology, specializing some domain-independent component of the master ontology, and containing new statements, that are not in the master ontology.

In some embodiments of the method according to the first aspect, the ETL module 32 shown in FIG. 2 is configured to receive the data from each of the at least one data sources and/or each of the at least one process data sources of the entity is also configured to provide the received data as input to the machine learning model.

In some embodiments of the method according to the first aspect, the method further comprises verifying, for example, using the data validation module 36 shown in FIG. 2 the classification of each data source classified by the machine learning model data classifier 34.

Advantageously, the use of master ontology allows, for example, a logic pattern ontology fragments to be used to infer other relationships and properties between that object instance in the knowledge graph and at least one other object in the knowledge graph.

The knowledge graph is an elastic knowledge graph in some if not all embodiments of the disclosed technology.

A benefit of the invention, is that it allows each digital twin represented as an instantiation in the elastic knowledge graph to be both spatially and temporally identified, in other words, the where and the when of the entity can always be determined from the unique geospatial identifies which represent the entity in the knowledge graph. Advantageously, this also allows the geo-spatial identifier of each instantiated object to also identify the position of the object in the system topology, i.e. relative to other objects.

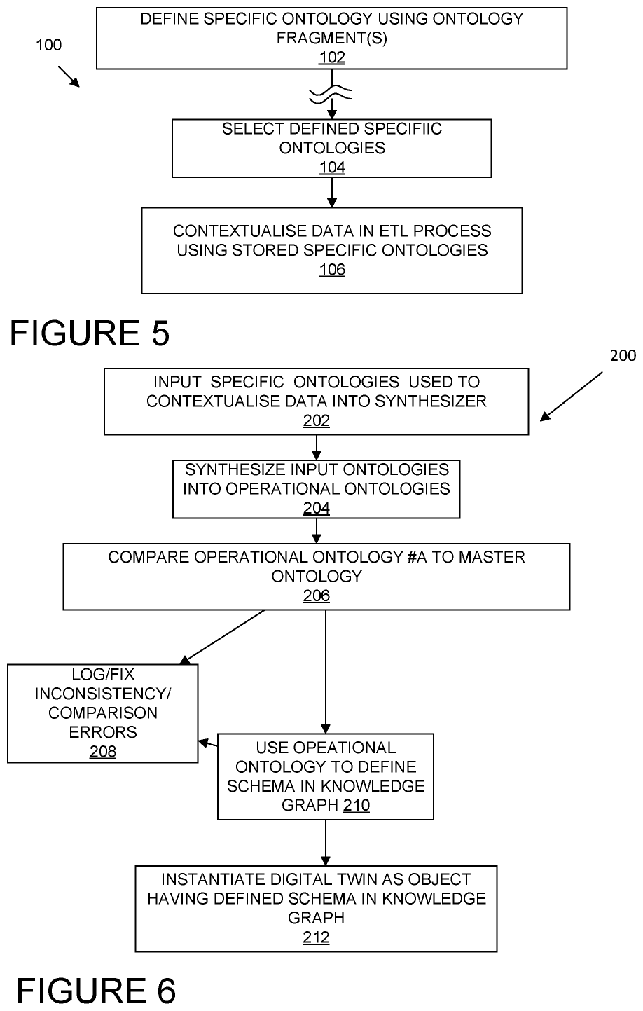

FIG. 5 shows schematically a method 100 in which specific ontologies, in other words, logic pattern ontology fragments, are first defined (step 102) by a user of an ontology editor, for example, a logic pattern ontology fragment editor such as that shown in FIG. 7 labelled as logic patterns ontology editor 74 in some embodiments. These ontologies, in other words the specific ontologies and the logic pattern ontology fragments they comprise, are stored in an ontology repository, for example, that shown in the FIG. 7 as logic pattern, repository 76. At some later point in time, a logic pattern service module 72, based on the characteristics of the ontology fragments, in other words, the logic pattern ontology fragments, that are included in that specific ontology, selects (step 104) a plurality of specific ontologies. In other words a plurality of specific logic pattern ontology fragments are selected. The selection is based on the data characteristics the component ontology fragments, in other words, the component logic pattern ontology fragments, having data characteristics which match data characteristics of the data being processed by the ETL module 32. The selected specific ontologies are then used by the ETL to contextualise the data being processed by the ETL when it is later stored.

FIG. 6 shows schematically a method 200 for synthesizing an operational ontology from a plurality of specific ontologies, in other words, from a plurality of logic pattern ontology fragments such as, for example, an asset logic pattern ontology fragment shown as asset specific ontology 22 in FIG. 6 and/or a process logic pattern ontology fragment, shown in FIG. 6 as process specific ontology 26. In some embodiments, the method 200 comprises first inputting the specific ontologies, in other words, the logic pattern ontology fragments, for the data sources of an entity 2 into an ontology synthesiser module 42 such as that shown schematically in FIG. 2 (and also later in FIG. 7) in step 202. The input ontologies, in other words, the input logic pattern ontology fragments, are then synthesized into an operational ontology, for example, by using a set of algorithms and techniques in step 204 and the logic of the operational ontology 28 is then compared or validated against the logic framework of a master ontology 24 in step 206 and errors or inconsistencies can then be picked up and/or logged for comment or remedial action in step 208. Once validated, the operational ontology output by the ontology synthesizer 42 provides a schema for a knowledge graph database 36 in step 210.

FIG. 7 shows another schematic example embodiment of a system 1 for generating digital twins 20 which shows more clearly the components of an embodiment of the elastic knowledge graph system 66 according to an embodiment of the disclosed technology. Elements in the drawings which are labelled logic pattern refer to logic pattern ontology fragments in FIG. 7.

In FIG. 7, the system 1 comprises at least one data source 4A,4B,4C and an extract load transform (ETL) module 32, an ontology module 40, at least one service delivery database 34A,346, 34C, a knowledge graph database 36, and an application programming interface (API) 38 via which service consumers 30 can access the digital twin service (the service consumers 30 are not shown in FIG. 3 for clarity, but examples 30A, 30B, 30C of service consumers are shown in the embodiment of system 1 shown in FIG. 2). Examples of service consumers 30 include a user device such as a computer, which may comprise a monitor and keyboard or touchscreen or other input means such as a brain-machine interface, or a headset or near-eye display or device, a tablet, smartphone or other similar mobile or fixed computing device which a user or a machine may operate or electronically controlled machinery or equipment, or another digital twin in some embodiments. The or each data source 4A, 4B is connected to the ETL module 32 by a conventional wired or wireless connection which allows data relating to one or more physical assets and/or processes to be transmitted from the data source 12A, 12B to the ETL module 14 for processing. For example, a 5G or 6G or later data communications network connection may be used or a shorter range connection such as WiFi, or Bluetooth, depending on the proximity of the data source to the server system 1. The data from the or one or more of the data sources 4A, 4B, 4C may be routed through a proxy to the ETL module 14 in some embodiments.

Examples of entities 2 which may be represented by digital twins 20 comprising asset data 10 and asset metadata 12 include a machine, equipment, or component of a machine or equipment, a transport network, building, or geospatial area like a campus or city, and may include both real and virtual assets, such as may be used in any industry sector including healthcare, manufacturing, energy generation, exploration for or extraction of fossil fuels, transportation etc. For example, an entity may comprise a mechanical structure such as a wind turbine or a drill string, a process such as the flow of steam through a steam turbine, or the flow of drilling mud through a wellbore drilling system, geospatial or time assets.

The data relating to the or each physical entity could include information about the shape, dimensions, weight, and/or material of a component of a mechanical system, the flow rate, temperature and/or pressure of a fluid flowing through a system, the chemical formula, chemical make-up, temperature and/or pressure of a reagent in a chemical process, the position of a component, the speed and/or direction of movement of a moving component, the speed of operation of machine such as a pump, compressor, engine, motor or conveyer, the manufacturer of a component, the logistics associated with a component.

Examples of a data source, such as data sources (s) 4A, 4B comprise one or more of the following: a web-service, an application programming interface, API, to another system (including, in some examples, a digital twin service system 1), an internet of things, IoT, device, live streams or data feeds comprising signals output from a sensor, an aggregated or normalised output data from a sensor or an external data files such a computer aided design (CAD) data file, or a SAP® data file.

In FIG. 7, a plurality of service delivery databases 34 are shown as the service delivery databases 34A, 34B 34C. Each service delivery database 34 may comprise local storage or cloud based storage and could comprise a single database or a plurality of databases 18. There could be one service delivery database for each data source, the data from one data source could be stored in more than one service delivery database, or the data from a plurality of data sources could be stored in a single service delivery database.

The ontology module 40 of FIG. 7 includes a data store for the specific ontologies, for example, for specific logic pattern ontology fragments, shown as logic pattern repository 76.

In some embodiments, the specific ontologies and all logic pattern ontology fragments comply with a framework established using a single master ontology or a set of master ontologies aligned among themselves. The master ontology in some embodiments, for example, defines a world view covering diverse areas ranging from defining a mechanical system as an assembly having one or more mechanical components, each of which has a set of characteristics such as an owner, a creator, a creation date, a mass, a shape, a volume, dimensions, a material from which it is made, or another type of domain-specific entity, etc. to including relationship knowledge that components within an assembly can be mechanically connected. The nature of various possible mechanical connections could also be defined at an abstract level in the master ontology and then further defined in more concrete terms using ontology fragments to make up the specialized ontologies. A master ontology includes generic, domain-independent concepts such as the concept of time, and the concept of measurement of a physical attribute of a system or its environment. A vocabulary defining all the possible types of physical parameters that could be measured temperature, pressure, flow rate, proximity, voltage, electric current are all examples described in the corresponding specialized ontology. Other specialised ontologies could be used to classify data based on characteristics such as the applicability of the general laws of physics to the entity/data source of that data. For example, Newton's laws of motion, the laws of gravity, Hooke's law relating to the deformation of elastic bodies, Boyle's for gases, the laws of thermodynamics etc.

The EKG system 66 shown in FIG. 7 comprises an ontology synthesizer 42 which may be implemented using one or more processor(s) or control circuitry and assembles a plurality of small specific ontologies, in other words, assembles a plurality of logic pattern ontology fragments, for the particular type of asset or process data that the ETL module 32 has collected or will collect from the entity whose digital twin is to be created. These specific process/asset ontologies are made to be compatible with/conform to the master ontology and are specific to the digital twin which is being created for that entity. The synthesizer selects only those specialized ontologies which are relevant to that specific digital twin. These process/asset ontologies accordingly define the components of the system and their relationships in general terms using the vocabulary and semantics of the master ontology. In some embodiments, the synthesizer is configured at least in part based on the type of asset data and/or process data generated by an asset or based on some other identifier. In some embodiments, some or all of the synthesizer configuration and/or the selection of which ontology fragments will form a specific ontology is performed manually.

For example if a digital twin is to be created to model a wind turbine, only the specialized ontologies relevant to the assembly of mechanical components forming a wind turbine, and the connections between the mechanical components in the wind turbine are used. If modelling of the mechanical forces experienced by the components in the wind turbine is required, specific ontologies for the different mathematical methods to be employed in determining these mechanical forces will be created. For example, if finite element analysis will be used to determine the forces on the components in the assembly, the specific finite element analysis ontology will include only the parts of the master ontology required to carry out this analysis. If data from a sensor is required to obtain the information required to carry out the desired modelling, for example a wind speed sensor, an ontology is created for that sensor. If the use of fluid dynamics is required to relate the wind speed and direction to the forces experienced by the turbine blades, relevant fluid dynamics ontology will be defined. The specific ontologies which are not relevant to the simulation in question, such as the laws of thermodynamics, Boyle's law etc. are not included for this digital twin.

If a digital twin is to be made to model the process of construction of the wind turbine, separate ontologies could be created not just for each process but also in relation to the manufacturer or supplier of a component or subassembly in the asset. The ontology could, for example, specify that the manufacturer or supplier has a name, a location, particular certifications, a number of employees etc. Separate ontologies could also be created for the logistical information associated with the supply or a component or sub-assembly.

Alternatively, if the asset is a drilling system, specific and operational ontologies 22, 26, 28 could be created for the top drive, each of the sensors in the top drive, each of the sub-assemblies in the top drive, the manufacturer of the top drive. To simulate a downhole event, in addition to these top drive ontologies, ontologies for the drill string, the drill bit, the geology of the formation to be drilled, the wellhead depth if subsea, all the relevant downhole sensors (pressure, temperature etc.), the mud composition, etc. would also be required.

The ETL module 32 is also connected to the EKG module 40 by a connection which allows information to be transmitted to the ETL module 32 for use in the processing of the data received from the or each data source 4A, 4B.

Thus in this case, and in some other embodiments, an ontology encompasses a representation of something which uses a formal naming schema which also provides definitions of the ontology categories, as well as properties and relations between the concepts, data and entities that substantiate one, many, or all data that the ontology describes. In other words, an ontology is a way of defining metadata for an asset (for example, an object such as a sensor, or component part of a machine or the machine itself, or the system the machine is in) or a process which shows the properties of the object and also other objects and indicates how the objects may be related, by defining a set of concepts and categories that represent the subject.

The data received by the ETL module 32 from the data sources 4A, 4B is processed by a data analytics processor 64 in FIG. 3. For example, in some embodiments, the data analytics process 64 may be used to implement a machine learning classifier model 34 (such as that shown in FIG. 2).

The ETL module 32 takes the data it receives from the or each data source 4A, 4B, of entity 2 and classifies it into process and/or asset data, and using the relevant process and/or asset ontologies 26, 22 transforms the process and/or asset data 10, 16 and generates relevant metadata 12, 18 for each type of data using a suitable specific ontology for that data source 4A, 4B and/or the type of data 4. For example, the ontology may be constructed in accordance with technical requirements which compress the ontologies to the smallest amount of data viable to fit any rules or constraints. Such rules and/or constraints may comprise technical specifications and/or business rules and/or quality requirements for the data and/or the specific ontologies 22, 26.

The metadata 12, 18 gives characteristic information about the data, and includes as a minimum geo-spatial and temporal information, but could also include additional contextual information. The asset and process data is then associated with the relevant metadata, for example, by a federation service module 68 which provides linkage and reference services between the delivery databases 34A, 34B, 34C and the knowledge graph data base, or EKG, database 36.

The ETL module 32 sends the data records 8, 14 comprising the transformed process and/or asset data 10, 16 and metadata 12, 18 to the relevant service delivery database(s) 34A, 34B, 34C for storage therein to service a particular type of service request from a service requesting entity 30.

As shown in FIG. 7, an ontology editor, for example, a logical patterns ontology editor 74, may be used to create the specific ontology and store it to the logic patterns repository 76, which hosts the master ontology and specialized ontologies used by a logic patterns management service module 72 of the EKG system 66. Once all the relevant process and/or asset ontologies have been created, these are synthesised together by an ontology synthesiser 42 to form an operational ontology 28 for the entity 2.

The operational ontology 28 is stored in its specialized repository and is being used to populate and update the knowledge graph database 36, along with reference data for the data collected in the or each service delivery database 34A, 34B, 34C.

In this manner, as was described earlier for the system shown in FIG. 2, an operating ontology 28 can be generated in order to represent in a mathematical way what is currently known or needed to be known about the structure of the entity 2, and its components, for example sensors and valves in the example where entity 2 comprises a valve system, and its relationships to other entities and internal relationships amongst its constituent parts. The operational or operating ontology 28 may be used to define a canonical schema for the digital twin knowledge graph stored in database 36 which uses data from the service delivery database(s) 34A, 34B, 34C to create a graph based representation of the entity. In some embodiments, reference metadata is created in the EKG in accordance with the operational ontology which references to data in the service delivery database(s) 34A, 34B, 34C which was contextualised using the schemas provided by the specific ontologies as part of the ETL process.

The synthesis process includes the steps of merging the process and/or asset ontologies, using information in the master ontology concerning the connections and relationships between the elements contained in the logic patterns within the process and/or asset ontologies to generate interconnections between the ontologies. Once these interconnections are established, and separate ontologies merged into a single new ontology, a verification process is carried out to establish if the new ontology is compatible with the master ontology, defined in terms of first order logic statements. Once it has been established that the new ontology is acceptable in these regards, the new ontology is designated as the operational ontology, and can be used as described above to create the knowledge graph.

As the process and/or asset ontologies define the assembly, its parts and relationships in general terms, these ontologies can be re-used in the creation of new digital twins.

Once the digital twin elastic knowledge graph (represented by the geo-spatial/temporal instantiation of the operational ontology in the knowledge graph) has been created using the operational ontology and relevant information from the or each service delivery database 34A, 34B, 34C as described above, the user may decide that they wish to use the digital twin in a different way—perhaps a different analysis of the structure/process is required, perhaps they want to now simulate a process for repair or replacement of one or more parts in the asset, or perhaps a new component or sub-assembly is to be added to the entity.

In this case, rather than having to start from scratch building a new database, one or more of original ontologies used in creating the original operational ontology can be changed, and/or new process and/or asset ontologies created, as required to ensure that new EKG is populated in accordance to the operational ontology and references the data from the service delivery databases 34A, 34B, 34C, so that the new digital twin to be used as desired. Rather than creating a new knowledge graph from scratch, the new operational ontology is used to mutate the existing reference data in and draw new reference data into the knowledge graph.

In the wind turbine example given above, the user may decide that, because the wind turbine is located in a corrosive environment—maybe offshore or in a coastal location where it exposed to salt water, they now wish to carry out a galvanic analysis of the structure in order to establish whether any parts may be particularly susceptible to corrosion. When the analysis was purely mechanical, a knowledge of the mechanical properties of the various components in the wind turbine was required and not their chemical compositions, and so the specific ontologies comprising logic pattern ontology fragments would not have been set up to extract the chemical composition information from the service delivery database. For a galvanic analysis, knowledge of the chemical compositions is required, but rather than having to start from scratch building a new knowledge graph for the new digital twin, the user can simply modify the existing asset ontologies relating to each relevant component in the wind turbine to bring in the chemical composition information for each component. They can also create a new process ontology or process ontologies covering the galvanic analysis. Similarly, if the issue now is the replacement of a part in the wind turbine, the original asset ontologies could be changed to draw in supplier information about one or more components in the assembly.

Once this is done, the process of merging the new set of ontologies, including the original ontologies used in creating the original knowledge graph, modified versions of the original ontologies and any new ontologies. As before, the master ontology is used as a reference to verify the validity of the merged ontologies, and to check that the first order logic statements in the ontologies are correct, and a new operational ontology is created. The new operational ontology is then used, as described above to generate a new knowledge graph. By virtue of re-using the original ontologies, and changing only those aspects which need to be changed, the new digital twin may be created in a relatively short space of time compared to having to start from scratch each time a change is required—possibly hours, rather than months.

Similarly, if it is desired to create a digital of a new entity, where there are overlaps in some characteristics of the new entity and the characteristics of the original entity, some of the ontology fragments and specific ontologies used in creating the digital twin of the original entity can be re-used in the creation of the digital twin of the new entity. Again, this may save significant time in creating the digital twin of the new entity.

For example, if a digital twin has been created for a wind turbine, but it is now desired to create a digital twin of a steam turbine, the asset ontologies relating to the physical structure of the assembly of the turbine blades, hub, generator etc. of the wind turbine, and the turbine blades, hub, generator etc. themselves, could be re-used, whilst new asset ontologies relating to the physical components of the steam turbine not present in a wind turbine—the conduits for directing the steam over the turbine blades for example, are added. Process ontologies relating to the generation and flow of the steam could also be created. The new set of ontologies can then be merged as described above to create the operational ontology for the steam turbine.

Moreover, as separate ontologies are created for all the different elements of the entity (both physical and conceptual), different people can work, simultaneously and entirely independently of one another, on creating or modifying the process and/or asset ontologies for different aspects of the system, before the synthesis process is carried out to merge all the logic patterns to form the operational ontology. One person may, for example, work on the asset ontologies for the mechanical aspects of an assembly, whilst someone else deals with the process ontologies for the logistics of the construction or repair of the assembly. This can also speed up the process of the creation of a new digital twin.

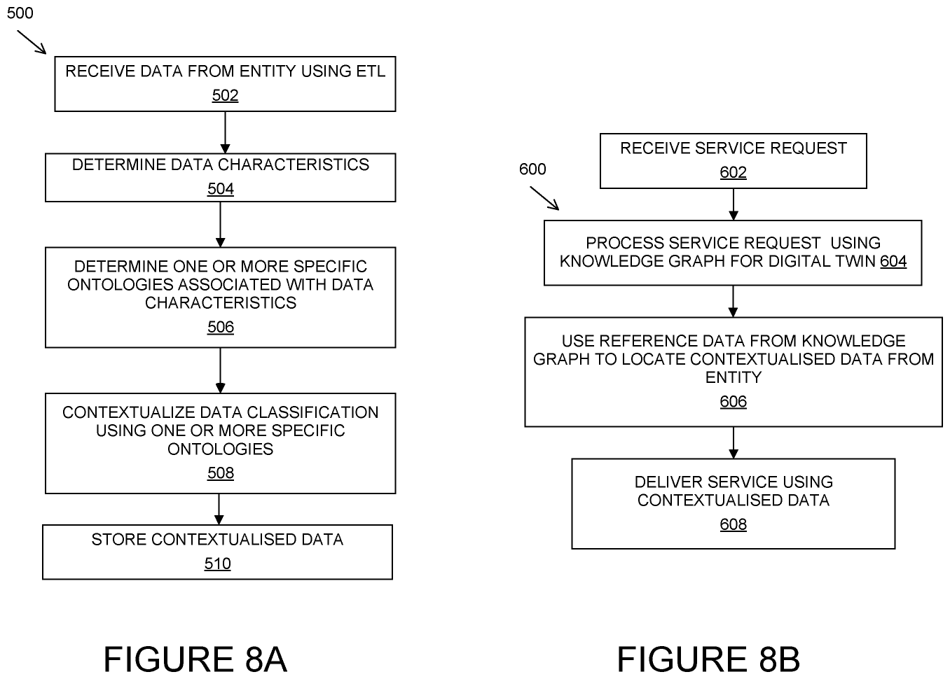

FIG. 8A shows schematically an embodiment of a computer implemented method 500 for determining one or more specific ontologies for contextualizing data received from an entity, for example, which some embodiments of the ETL 32 of FIG. 2 or 7 may perform.

In step 502, data is received from an entity 2 by the ETL module 32. For example, the data may comprise asset data 10 and process data 16 from a plurality of heterogeneous data sources 4A, 4B, 4C of an entity 2. The data may be pushed by the entity 2 or it may be pulled or otherwise collected or scraped by the ETL module 32 from each data source 4.

In step 504, the ETL module 32 determined characteristics of the data, for example, which are associated with one or more specific ontologies in step 506. The one or more specific ontologies each comprise ontology fragments which are associated with sub-sets of the one or more characteristics of each data category 10, 16, and/or a data source 4 for that data category 10, 16 and/or the entity 2. Each specific ontology is determined based on the suitability of its ontology fragments meeting selection criteria for classifying the data from the entity appropriately. The ontology fragments are then used to contextualise the data received from the entity 2 so that the ETL can classify the data into different classifications, such as asset or process data, and store each classification of received data in an appropriate schema based on the specific ontology used to contextualise that data (step 510).

FIG. 8B shows schematically an example embodiment of a method 600 for providing a service using a digital twin represented by a schema of an elastic knowledge graph to a servicing consumer device 30A, 30B, 30C. In FIG. 8B the method 600 comprises the knowledge graph data-base 36, or EKG, which uses a schema for a particular digital twin where the schema is defined using an operational ontology synthesized using any of the embodiments of the method of the first aspect disclosed herein. Method 600 comprises receiving, via API 38 of FIG. 2 or 7, a service request in step 602 from a requesting entity 30, processing the request using the EKG for the digital twin of the entity (step 604) to reference the relevant data from the entity 2 which was contextualised using the specific ontologies used to form the operational ontology whose scheme is used by the EKG in step 606, and using the referenced data to deliver the requested service in step 610.

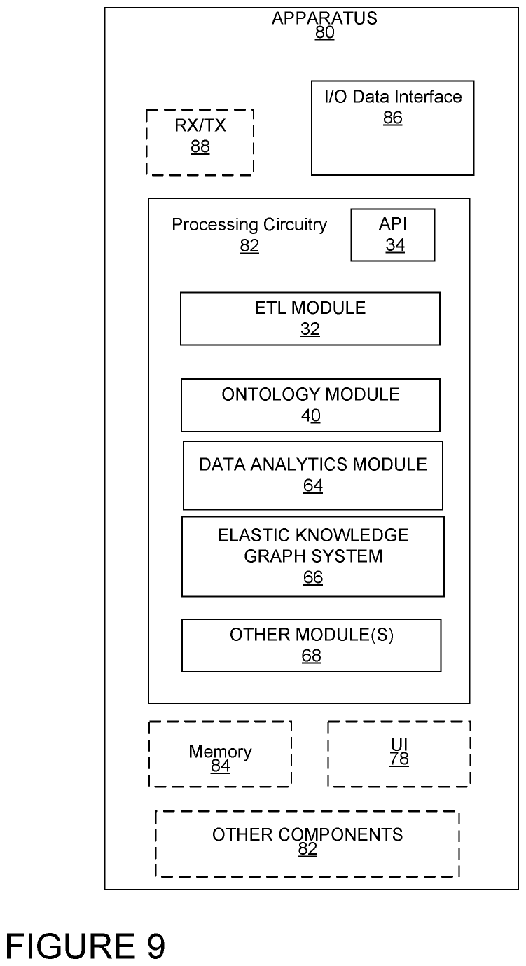

Referring now to FIG. 9, there is shown a block diagram of apparatus 80 comprising computer components including hardware and circuitry suitable for implementing any or all of the various embodiments and methods aspects described above. The apparatus 80 may be provided as a stand-alone platform or using one or more platforms, for example, as a server or server system, and may be provided in a distributed or cloud-based form in some embodiments.

In some embodiments, the apparatus comprises a computer system.

The apparatus 80 comprises processing circuitry 82 and a memory 84 as shown in FIG. 9. The memory 84 is configured to hold computer program code which when loaded by the processing circuitry 82 causes the apparatus to implement any one of the disclosed embodiments of any of the methods disclosed herein. The memory 84 may include a random access memory (RAM) or other dynamic storage device for storing information and instructions to be executed by the processing circuitry 82 along with temporary variables or other intermediate information generated or used during execution of the instructions by the processing circuitry 82, and a read only memory (ROM) or other static storage device for storing static information and instructions for the processing circuitry.

The apparatus 80 also includes an input/output data interface 86 by means of which data from the data sources 4A, 4B, 4C may be transmitted to the ETL module 32, and which can be used by the API 38 to communicate with a service consuming entity 30A, 30B, 30C. The memory 84 may provide the logic patterns repository 76, storage for the knowledge graph database 36 and the service delivery databases 34A, 34B, 34C, or one of these may be provided by one or more external storage devices (not shown in FIG. 6) such as a magnetic or optical disc, or flash memory connected to the processing circuitry 82 via the I/O data interface 86.

The processing circuitry 82 is used to carry out the processing activity described in relation to the ETL module 32, the ontology module 40, the elastic knowledge graph system 66, the federation service module 68 (which functions as a linkage and reference service module 68 for the asset/process data 10, 16 and asset/process metadata 12, 18 and the operational ontology data 28 in the EKG store 36), and the API 38 by the execution of sequences of instructions stored in the memory 84. It will be appreciated that the instructions may be read into the memory 84 from another machine read-able medium such as the storage device described above.

In some embodiments, some or all of the functionality described herein as being performed by the apparatus 80 may be provided by the control or processing circuitry executing instructions stored on memory or other form of computer-readable storage medium. In alternative embodiments, some or all of the functionality may be provided by control or processing circuitry without executing instructions stored in memory, such as in a hard-wired manner. The control or processing circuitry may be configured to perform any one or more or all of the determining, calculating, or similar operations (e.g., certain obtaining operations) described herein as being performed by an embodiment of the apparatus 80 comprising means or structural components such as the modules shown in FIG. 9 which are configured to implement a method according to the first aspect or any of the embodiments of the first aspect (or any other aspect disclosed herein).

Memory 84 as illustrated in FIG. 9 is operable to store at least one computer program, software, or application comprising a set of instructions capable of being executed by processing circuitry 82. Memory 94 may include computer memory (e.g., Random Access Memory, RAM, or Read Only Memory, ROM), mass storage media (e.g., a hard disk), removable storage media (e.g., a flash drive or other form of memory stick, a Compact Disk, CD or a Digital Video Disk, DVD, or removable memory drive), and/or any other volatile or non-volatile, persistent or semi-persistent, non-transitory device readable and/or computer executable memory devices that store information, data, and/or instructions that may be used by processing circuitry 82, such as a PROM, EPROM, or FLASH-EPROM, or similar form of memory chip or component. It should be appreciated, however, that in alternative embodiments, hard-wired circuitry may be used in place of or in combination with software instructions to implement the invention. In some embodiments, the processing circuitry 82 comprises one or more processors and/or is part of control circuitry or a controller and is integrated with memory 84. Memory 84 may also be distributed and be provided in part remotely in some embodiments.

The apparatus 80 also includes a user interface 78 by means of which a user may enter commands and information to the processing circuitry 82 of the apparatus 80 through input devices such as a keyboard, touch screen, mouse, trackball, joystick touchpad or microphone (not shown although these may be represented by other components 82 in the example schematic of apparatus 80 shown in FIG. 9). For example, apparatus 80 may include auxiliary equipment 82 such as a visual display unit, touch screen, or near-eye display or brain machine interface in some embodiments.

The various components of the apparatus described above are coupled to the processing circuitry 82 using a system bus in some embodiments (not shown in FIG. 9 for the sake of clarity). The apparatus 80 further comprises a power source from which power is supplied to the above components via power circuitry, which are not shown in FIG. 9 for the sake of clarity.

It will be appreciated that embodiments of the disclosure are operational with numerous other general purpose or special purpose computing systems environments or configurations. Examples of well-known computing systems, environments or other configurations that may be suitable for use with the systems and methods described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

It will be appreciated that rather than being implemented using a single computer as described above, the methods described above could be implemented using a plurality of computers operating in a networked environment using logical connections to one or more remote computers. For example, the processing steps of the ontology module 40 may be carried out by one computer, the processing steps of the ETL module 32 by a different computer, and a further computer providing the elastic knowledge graph system 50. The remote computer may be a personal computer, a hand-held device, a server, a router, a network PC, a peer device or other common network node, and may include one, more, or all of the elements described in relation to the computer. The logical connections include a local area network (LAN) and a wide area network (WAN). The logical connections may include other networks. The other networks may be included in combination with the LAN or WAN. Such networking environments are commonplace in offices, enterprise-wide computer networks, intranets and the internet.

In the context of the disclosed technology, first order logic is a method to validate relationships between two things. It is not knowledge, it defines a set of rules to check and validate the way ontology elements are used. To apply first order logic a semantic reasoner is used of a type that would be apparent to any one of ordinary skill in the art as being suitable for such a use. An ontology can define anything and it can do it well or poorly, it can define something from a specific point of view, and a reasoner is used in some embodiments to verify that an ontology is describing a concept in a way that meets first-order logics (FOL) criteria. The reasoner can be applied to any ontology comprising ontology fragments such as, any set of logic pattern ontology fragments. The reasoner is dumb/blind, it will apply it's criteria to anything and everything apply it to.

An ontology fragment which is a logic pattern (LP) is a subset of the master ontologies and covers only a specific scope, in other words, a logic pattern ontology fragment provides a specification of a fragment of the master ontology, also referred to herein as a specific ontology. For example a machine (a heat sensor), a process (a sale), a government structure (parliamentary democracy, an idea (risk), or some logic (a wheel goes around an axis). They are reusable, the parliamentary democracy LP can be used for any parliamentary democracy whiteout making any change.

The knowledge representation language used in some embodiments is called OWL 2, this is a standard for defining ontologies. For example, an ontology fragment contains the information of how on/off or partially on or off a thing may be such as a valve. In the ETL process data from the sensor, it might have sensor reading that say 0, 0.5 and 1, but it might alternatively have on, off, half open. Or it might have degrees from off between 0 and 259 or from 1 and 360, or it might show it in percent 0% 50%, 100%. These different ways of describing the value open/close will vary wildly, the ETL process (using the ontology fragment) will convert it to whatever format is to be used for the digital twin. An ontology is not used to define all of the possible ways something can be described, but how the data should be contextualised and then ETL does a transformation to our desired format. That transformation by the ETL is represented by an ontology so the contextualisation of the data is also made more visible.

In some embodiments, an operational ontology triggers CRUD operations to modify the graph DB to become in line with the new operational ontology. The data in the delivery database (SDD) is not changed, the structure and relationships of the graph DB that points to the SDD data changes. For example, let's say we have a bunch of assets and sensor data etc. then the customer implements a new International Standards Organisation, ISO, naming convention. This change is modified in the ontology, then that causes the CRUD operations to create new nodes and relationships in the graph database that change names and add nodes for the ISO standards elements. But the metadata pointing to the sensor reading data in a service delivery database remains the same.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the disclosure may be at least in part implemented by means of both hardware and software, and that several “means” or “units” may be represented by the same item of hardware.

Although the figures described in the description may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. The above mentioned and described embodiments are only given as examples and should not be limiting to the present disclosure. Other solutions, uses, objectives, and functions within the scope of the disclosure as claimed in the below described patent embodiments should be apparent for the person skilled in the art.

A person skilled in the art will realize that the present disclosure is not limited to the preferred embodiments described above. The person skilled in the art will further realize that modifications and variations are possible within the scope of the appended claims. Additionally, variations to the disclosed embodiments can be understood and effected by the skilled person in practicing the claimed disclosure, from a study of the drawings, the disclosure, and the appended claims. For example, one or more or all of the disclosed methods may, in at least some if not all embodiments, be implemented as computer-implemented methods and vice versa.

1. (canceled)

2. The method of claim 25, wherein validating the operational ontology comprises ontology fragments of specific ontologies defined in accordance with the master ontology.

3. The method of claim 25, wherein geo-spatial and temporal identifiers from each specific ontology are used to contextualise data from the entity, wherein the geo-spatial and temporal identifiers uniquely identify that entity in stored contextualised data.

4. The method of claim 25, wherein the entity is a heterogeneous data source providing data having a plurality of different data classifications.

5. (canceled)

6. The method of claim 27, wherein at least one data classification comprises at least one of (i) a process data classification and (ii) an asset data classification.

7. The method of claim 27, wherein during the ETL process, the characteristics of the received data are determined using a machine learning model classifier.

8. The method of claim 7, wherein during the ETL process, the data is contextualised using one or more ontologies having characteristics which match the characteristics of the data determined using the machine learning model classifier.

9. The method of claim 8, wherein the data is contextualised into at least one data classification using the one or more ontologies.

10. (canceled)

11. The method of claim 25, wherein the operational and specific ontologies include re-definable ontology fragments previously used to contextualise another entity.

12. The method of claim 11, wherein the method further comprises:
determining the data being processed by the ETL from the entity has characteristics which can be associated with at least one data classification similar to a data classification of characteristics of the other entity; and
obtaining one or more ontology fragments of at least one specific ontology of the other entity for each similar data classification,
wherein at least one of the specific ontologies is formed from an ontology fragment comprising geo-spatial and/or temporal identifiers for the entity and the obtained ontology fragments of the other entity.

13. The method of claim 11 or 12, wherein the synthesized operational ontology for the entity is synthesized using the specific ontologies which include the obtained ontology fragments of the other entity.

14. The method of claim 25, wherein the plurality of specific ontologies comprise a plurality of logic pattern ontology fragments which each provide a specification of a fragment of a master ontology.

15. The method of claim 25, comprising generating a digital twin representation of a real or virtual entity comprising at least one data source by:
using the synthesized operational ontology to define a schema for a knowledge graph of the entity, and
forming a digital twin for the entity by instantiating the operational ontology as an object in the knowledge graph which includes geo-spatial and temporal identifiers from each specific ontology from which the operational ontology was synthesized.

16. The method of claim 15, further comprising providing a digital twin service to a requesting entity by:
receiving a request for service from the requesting entity;
processing the request to determine one or more service characteristics;
processing the service request using the operational ontology for the digital twin generated; and
providing the service to the requesting entity or to another entity identified in the service request.

17. An apparatus for generating a digital twin representation of a real or virtual entity comprising at least one data source, the apparatus comprising:
means to use a synthesized operational ontology to define a schema for a knowledge graph of the entity; and
means to form a digital twin for the entity by instantiating the operational ontology as an object in the knowledge graph which includes geo-spatial and temporal identifiers from each specific ontology from which the operational ontology was synthesized, wherein the operational ontology is synthesized using a method comprising:
inputting the specific ontologies for data sources of an entity into an ontology synthesizer module;
synthesizing the input ontologies into an operational ontology by using a set of algorithms and techniques;
performing at least one of: (i) comparing and (ii) validating the logic of the operational ontology against the logic framework of a master ontology;
logging errors or inconsistencies for comment or remedial action;
validating the operational ontology output by the ontology synthesizer; and
providing the output of the ontology synthesizer as a schema for a knowledge graph database.

18. The apparatus of claim 17, further comprising:
an extract transform load, ETL, system;
means for obtaining, using the ETL system, data from the entity;
means for contextualising, as part of a ETL process performed by the ETL system, the obtained data using a plurality of specific ontologies, wherein each specific ontology comprises one or more ontology fragments forming a set of characteristics for a data classification of the data from the entity;
a data store for storing, using a representation of each specific ontology which contextualises a data classification of the data, at least that classification of the data in a data store, wherein the representation provides a schema for storing the data having the data classification in the data store; and
means to synthesize an operational ontology for the entity using the plurality of specific ontologies.

19. (canceled)

20. (canceled)

21. (canceled)

22. (canceled)

23. (canceled)

24. A system for generating a digital twin representation of a real or virtual entity comprising a plurality of heterogeneous data sources, the system comprising:
an extract transform load, ETL, module configured to process heterogeneous data from the entity into a plurality of data classifications;
an ontology module configured to define a specific ontology associated with a data classification including unique geo-spatial and temporal identifiers for each source of data of the entity to each classification of data;
at least one database configured to store the data of each classification using a schema defined by a corresponding specific ontology for that classification;
a knowledge graph data base configured and populated using a schema defined by an operational ontology for a digital twin of the entity, the operational ontology being synthesized from the plurality of specific ontologies used to classify the data of the entity;
wherein a data classification optionally comprises an asset data classification and wherein asset operational ontology metadata is associated with each asset data classification, wherein the asset operational ontology metadata is stored in a knowledge graph data store for asset data of a plurality of different entities; and
wherein a data classification optionally comprises a process data classification and wherein operational ontology metadata is associated with each process data classification, wherein the process operational ontology metadata is stored in a knowledge-graph data store for process data of a plurality of different entities.

25. A method for synthesizing an operational ontology from a plurality of specific ontologies, comprising one or more of:
(i) an asset specific ontology,
(ii) a process specific ontology;
wherein the method comprises:
inputting the specific ontologies for data sources of an entity into an ontology synthesizer module;
synthesizing the input ontologies into an operational ontology by using a set of algorithms and techniques;
performing at least one of: (i) comparing and (ii) validating the logic of the operational ontology against the logic framework of a master ontology;
logging errors or inconsistencies for comment or remedial action;
validating the operational ontology output by the ontology synthesizer; and
providing the output of the ontology synthesizer as a schema for a knowledge graph database.

26. The method of claim 25, wherein the method synthesizes an operational ontology for a digital twin of a real or virtual entity comprising at least one data source, using data from the entity obtained by using an extract transform load, ETL, system.

27. The method of claim 25, wherein the method comprises synthesizing an operational ontology for a digital twin of a real or virtual entity comprising at least one data source by:
obtaining, using an extract transform load, ETL, system, data from the entity;
as part of the ETL process, contextualising the obtained data using a plurality of specific ontologies, wherein each specific ontology comprises one or more ontology fragments forming a set of characteristics for a data classification of the data from the entity;
for each specific ontology, using a representation of that specific ontology to contextualise a data classification of the data in a data store; and
synthesizing an operational ontology for the entity using the plurality of specific ontologies.

28. The method of claim 27, wherein the geo-spatial and temporal identifiers are included in the specific ontologies assigned to the data of each data classification to uniquely identify the data source of each data classification.
